(19) United States
(12) Patent Application Publication
(10) Pub. No.: US 2019/0278224 A1
(43) Pub. Date: Sep. 12, 2019

(54) HOLOGRAM RECORDING SYSTEMS AND OPTICAL RECORDING CELLS

(71) Applicant: Akonia Holographics LLC, Longmont, CO (US)

(72) Inventors: Friso Schlottau, Lyons, CO (US); Adam C. Urness, Louisville, CO (US); Kenneth E. Anderson, Longmont, CO (US); Mark R. Ayres, Boulder, CO (US)

(21) Appl. No.: 16/461,325

(22) PCT Filed: Nov. 17, 2017
(86) PCT No.: PCT/US17/62431

§ 371 Date: May 15, 2019

Related U.S. Application Data
(60) Provisional application No. 62/423,590, filed on Nov. 17, 2016.
(60) Provisional application No. 62/423,761, filed on Nov. 17, 2016.

(51) Int. Cl. G03H 1/04

(52) U.S. Cl. CPC G03H 1/0402; G03H 1/0486; G03H 2222/12; G03H 2001/0439; G03H 2223/25; G03H 1/0465

(57) ABSTRACT

A system and method making one or more holographic optical elements is disclosed. The method may include at least partially submerging a recording medium in an index matching fluid residing in a fluid reservoir. A first surface of the fluid reservoir may include a surface of a first optical coupling element. The method may include positioning the recording medium with respect to the surface of the first optical coupling element. The method may also include applying a first recording beam through the first optical coupling element, the index matching fluid, and a first portion of the recording medium to form a hologram in the first portion of the recording medium.

### CROSS-REFERENCE TO RELATED PATENT APPLICATIONS

This application claims priority from co-pending U.S. Application Nos. 62/423,590, filed 17 Nov. 2016, and titled “HOLOGRAM RECORDING SYSTEMS AND METHODS OF USE,” and 62/423,761, filed 17 Nov. 2016, and titled “OPTICAL RECORDING CELLS, METHODS OF USE, AND METHODS OF MANUFACTURE.” The above applications are incorporated herein by reference for all purposes, in their entireties.

### FIELD OF TECHNOLOGY

The present disclosure relates generally to optical reflective devices, and more specifically to manufacturing holographic optical elements.

### BACKGROUND

Holograms may be implemented within optical media. Challenges associated with proper recording of the holograms within optical media and alignment of waveguide surfaces may introduce unwanted reflective characteristics of an optical reflective device. Accordingly, improved systems and methods to promote efficient hologram recording and manufacture holographic optical elements are desired.

### SUMMARY

The described features generally relate to one or more improved methods, systems, or devices for recording optical signals in a recording medium. The optical signals are typically recorded as holograms. The recording medium may reside within or otherwise be supported by a substrate structure. The substrate structure may comprise one or more substrates oriented parallel to each other. A combination of the recording medium and substrate structure may be referred to as an optical recording cell. Fabrication of the optical recording cell may include deposition of a liquid medium mixture on or in the substrate structure, whereupon polymerization of matrix precursors within the medium mixture results in formation of a matrix polymer, which characterized transition of the medium mixture to become a recording medium. In contrast to the liquid medium mixture, the recoding medium is typically a rubbery solid at room temperature that may lend structural support to the optical recording cell. One or more assembly mechanisms may support and orient the substrates in order to sustain the substrates in a parallel orientation, at least until the solid recording medium forms from the media mixture. The assembly mechanisms may furthermore promote dispersion of the media mixture within the substrate structure. In addition, the described features relate to performing a hologram recording process within an environment that is substantially index-matched to the recording medium, to thereby produce a holographic optical element. Recording a hologram in the recording medium may be referred to as programming the recording medium or programming the holographic optical element. One or more methods may be implemented to enhance lateral and longitudinal mobility of an optical recording cell for performing pluralized hologram recording for a set of recording media. The recording media may be treated with spatially and/or temporally incoherent light following hologram recording, and singulated into respective holographic optical elements.

A method of making is described. The method may include at least partially submerging a recording medium in an index matching fluid residing in a fluid reservoir, wherein a first surface of the fluid reservoir comprises a surface of a first optical coupling element or a surface coupled to the first optical coupling element, positioning the recording medium with respect to the surface of the first optical coupling element, and applying a first recording beam through the first optical coupling element, the index matching fluid, and a first portion of the recording medium to form a hologram in the first portion of the recording medium.

An apparatus is described. The apparatus may be configured to at least partially submerging a recording medium in an index matching fluid residing in a fluid reservoir, wherein a first surface of the fluid reservoir comprises a surface of a first optical coupling element or a surface coupled to the first optical coupling element, position the recording medium with respect to the surface of the first optical coupling element, and apply a first recording beam through the first optical coupling element, the index matching fluid, and a first portion of the recording medium to form a hologram in the first portion of the recording medium.

Some examples of the method and apparatus described above may further include processes or features for applying a second recording beam through the first optical coupling element, the index matching fluid, and the first portion of the recording medium to form the hologram in the first portion of the recording medium. Some examples of the method and apparatus described above may further include processes or features for applying a second recording beam through the second optical coupling element, the index matching fluid, and the first portion of the recording medium to form the hologram in the first portion of the recording medium.

In some examples of the method and apparatus described above, a plane of the first surface of the fluid reservoir may be parallel to the a plane of the second surface of the fluid reservoir. In some examples of the method and apparatus described above, the hologram in the first portion of the recording medium may be formed based at least in part on interference between the first recording beam and the second recording beam.

Some examples of the method and apparatus described above may further include processes or features for applying a force to at least one of the first surface of the fluid reservoir or another portion of the fluid reservoir such that the first surface of the fluid reservoir moves closer to the recording medium. In some examples of the method and apparatus described above, the index matching fluid may have an index of refraction that may be within 0. In some examples of the method and apparatus described above, the index matching fluid may have an index of refraction that may be within 0.10 of an index of refraction of the first optical coupling element. In some examples of the method and apparatus described above, the index matching fluid may have an index of refraction that may be within 0.025 of an index of refraction of the first optical coupling element. In some examples of the method and apparatus described above, the index matching fluid may have an index of refraction that may be within 0.010 of an index of refraction of the first optical coupling element.

In some examples of the method and apparatus described above, the index matching fluid has an index of refraction that is within 0.025 of an index of refraction of the first optical coupling element when subject to a wavelength of the first recording beam and has an index of refraction that is greater than 0.10 of the index of refraction of the first optical coupling element when subject to a wavelength of light different from the wavelength of the first recording beam. In some examples of the method and apparatus described above, the first recording beam may have a wavelength of approximately 405 nm. Some examples of the method and apparatus described above may further include processes or features for moving at least one of the recording medium, the first optical coupling element, or a position of the first recording beam with respect to at least one of the recording medium or the first optical coupling element. Some examples of the method and apparatus described above may further include processes or features for applying the first recording beam through the first optical coupling element, the index matching fluid, and a second portion of the recording medium different from the first portion to form a hologram in the second portion of the recording medium.

Some examples of the method and apparatus described above may further include processes or features for applying a second recording beam through the first optical coupling element, the index matching fluid, and a second portion of the recording medium different from the first portion to form a hologram in the second portion of the recording medium.

Some examples of the method and apparatus described above may further include processes or features for applying a second recording beam through the second optical coupling element, the index matching fluid, and a second portion of the recording medium different from the first portion to form a hologram in the second portion of the recording medium.

Another method of making is described. The method may include securing a first substrate substantially parallel to a second substrate, wherein the first substrate is spaced apart from the second substrate, adding a media mixture to a space between the first substrate and the second substrate, solidifying the media mixture to form a recording medium, and applying a first recording beam through a first portion of the recording medium to form a hologram in the first portion of the recording medium.

Another apparatus is described. The apparatus may be configured to secure a first substrate substantially parallel to a second substrate, wherein the first substrate is spaced apart from the second substrate, add a media mixture to a space between the first substrate and the second substrate, solidify the media mixture to form a recording medium, and apply a first recording beam through a first portion of the recording medium to form a hologram in the first portion of the recording medium.

Some examples of the method and apparatus described above may further include processes or features for adjusting, after adding a media mixture, a position of at least one of the first substrate or the second substrate. Some examples of the method and apparatus described above may further include processes or features for dispensing adhesive material on a surface of at least one of the first substrate or the second substrate, wherein the adhesive material may be dispensed proximal to a perimeter edge on the surface of the at least one of the first substrate or the second substrate for at least partially confining the media mixture between the first substrate and the second substrate.

In some examples of the method and apparatus described above, securing a first substrate substantially parallel to a second substrate comprises: applying a suction force to a surface of at least one of the first substrate or the second substrate. In some examples of the method and apparatus described above, at least one of a plurality of micrometers may be used to adjust the position of at least one of the first substrate or the second substrate. In some examples of the method and apparatus described above, an interferometry system may be used to adjust the position of at least one of the first substrate or the second substrate. In some examples of the method and apparatus described above, a spacer layer may be disposed between the first substrate and the second substrate. In some examples of the method and apparatus described above, the spacer layer includes two or more openings a space between the first substrate and the second substrate.

Some examples of the method and apparatus described above may further include processes or features for aligning the first substrate substantially parallel to the second substrate, the aligning based at least in part on positioning one or more calibrated spacers between the first optical flat and second optical flat

### BRIEF DESCRIPTION OF THE DRAWINGS

A further understanding of the nature and advantages of implementations of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIGS. 1A and 1B illustrate diagrams of systems that can be used for manufacturing holographic optical elements in accordance with various aspects of the disclosure.

FIGS. 2A through 2C illustrate diagrams of systems that can be used for manufacturing holographic optical elements in accordance with various aspects of the disclosure.

FIGS. 3A and 3B illustrate a diagram of a mechanical system that can be used for manufacturing a holographic optical element in accordance with various aspects of the present disclosure.

FIG. 4 illustrates a diagram of a mechanical system that can be used for manufacturing a holographic optical element in accordance with various aspects of the present disclosure.

FIGS. 5A and 5B illustrate examples of perspective views of a pre-sealed optical structure that supports manufacturing a holographic optical element in accordance with various aspects of the present disclosure.

FIG. 6 illustrates properties of an optical structure that supports manufacturing a holographic optical element in accordance with various aspects of the present disclosure.

FIGS. 7A and 7B illustrate properties of an optical structure that supports manufacturing a holographic optical element in accordance with various aspects of the present disclosure.

FIGS. 8A and 8B illustrate properties of an optical structure that supports manufacturing a holographic optical element in accordance with various aspects of the present disclosure.

FIG. 9 illustrates an example of an optical system that can be used for edge coupling in association with manufacturing a holographic optical element in accordance with various aspects of the present disclosure.

FIG. 10 illustrates an example of an optical system that can be used for edge coupling in association with manufacturing a holographic optical element in accordance with various aspects of the present disclosure.

FIG. 11 illustrates an example of an optical system that can be used for edge coupling in association with manufacturing a holographic optical element in accordance with various aspects of the present disclosure.

FIG. 12 illustrates an example of an optical system that can be used for edge coupling in association with manufacturing a holographic optical element in accordance with various aspects of the present disclosure.

FIG. 13 illustrates an example of an optical system that can be used for edge coupling in association with manufacturing a holographic optical element in accordance with various aspects of the present disclosure.

FIG. 14 illustrates an example of an optical system that can be used for edge coupling in association with manufacturing a holographic optical element in accordance with various aspects of the present disclosure.

FIG. 15 illustrates an example of an optical system that can be used for manufacturing a holographic optical element in accordance with various aspects of the present disclosure.

FIGS. 16A and 16B illustrate examples of an optical system that can be used for manufacturing a holographic optical element in accordance with various aspects of the present disclosure.

FIG. 17 illustrates an example of an optical system that can be used for high volume hologram recording in association with manufacturing a holographic optical element in accordance with various aspects of the present disclosure.

FIG. 18 illustrates an example of an optical system that can be used for fast hologram recording in association with manufacturing a holographic optical element in accordance with various aspects of the present disclosure.

FIG. 19 illustrates an example of an optical system that can be used for fast hologram recording in association with manufacturing a holographic optical element in accordance with various aspects of the present disclosure.

FIG. 20 illustrates an example of an optical system that can be used for fast hologram recording in association with manufacturing a holographic optical element in accordance with various aspects of the present disclosure.

FIG. 21 illustrates an example of an optical system that can be used for fast hologram recording in association with manufacturing a holographic optical element in accordance with various aspects of the present disclosure.

FIG. 22A is a diagram illustrating reflective properties of a holographic optical element in real space in accordance with various aspects of the disclosure.

FIG. 22B illustrates a holographic optical element in k-space in accordance with various aspects of the disclosure.

FIG. 23 is a diagram of an optical component illustrating a plurality of hologram recordings in accordance with various aspects of the disclosure.

### DETAILED DESCRIPTION

Holographic optical elements may be fabricated by deposition of a liquid medium mixture on or in the substrate structure, whereupon polymerization of matrix precursors within the medium mixture results in formation of a matrix polymer, which characterized transition of the medium mixture to become a recording medium. One or more assembly mechanisms may support and orient the substrates in order to sustain the substrates in a parallel orientation, at least until the solid recording medium forms from the media mixture. The assembly mechanisms may furthermore promote dispersion of the media mixture within the substrate structure. In addition, the described features relate to performing a hologram recording process within an environment that is substantially index-matched to the recording medium, to thereby produce a holographic optical element. The additional features may include at least edge sealed structural materials to protect media from environmental degradation, and partially reflective surfaces and/or coatings employed at portions of the substrates as a means to promote pupil homogenization. In some embodiments, the edge seal may reduce escape of a volatile component from the recording medium or holographic optical element caused therefrom. Pupil homogenization may refer to the replication of incident light at the recording cell, without invariance or interference between reflected light beams (e.g., modes). Mechanisms for orienting the parallel substrates of the recording cell, including the spacing of parallel substrates, as well as edge coupling (e.g., cutting and polishing one or more substrate edges at an angular offset) may also aid sustaining parallelism.

A mechanical assembly (e.g., a jig assembly) may be used to fabricate the optical recording cell via the implementation of optical flats mounted to oriented bearings. An adjustment apparatus of the mechanical assembly and/or one or more spacers may allow for variant adjustment of orientation and spacing between optical flats. Vacuum channels may be cut into the optical flats for statically sustaining placed substrates, and a mounted mechanism may dispense the medium mixture onto at least one of the substrates of the optical recording cell. The adjustment apparatus, which may comprise a micrometer, may be configured to make precise adjustments.

In some embodiments, a medium mixture may be dispersed within substrates prior to sealing of the substrates and fabrication of the optical recording cell. For example, substrates may be cleaned and placed on optical flats of the mechanical assembly. At least one of the substrates may contain an edge seal for optical cell composition. A mount of the mechanical assembly may dispense the medium mixture onto at least one of the substrates. Micrometers or other adjustment apparatus may precisely adjust top optical flat toward bottom optical flat, registering a configured spacing between the substrates correlated to the desired media thickness and allowing the medium mixture to spread to fill the desired region. The substrates may then be registered mechanically and/or visually for orientation and the promotion of edge alignment and parallelism between the substrates of the constructed optical cell. In other examples, the substrates may be cleaned and placed on the optical flats of the mechanical assembly. A mount of the mechanical assembly may dispense the medium mixture onto at least one of the substrates. The top optical flat may be adjusted toward the bottom optical flat to a precisely configured distance between the optical flats. The configured distance may be indicated or determined by calibrated spacers, which may reside between the optical flats. The distance associated with the spacers may correlate to the desired media thickens and allow the medium mixture to spread to fill the desired region bounded by the substrates. Similarly, the substrates may then be registered mechanically and/or visually for orientation and the promotion of edge alignment and parallelism between the substrates of the constructed optical cell.

Alternatively, in other embodiments, substrates may be oriented and sealed to construct an optical recording cell prior to dispersion of media components. Adhesive and/or structural materials may be dispensed onto the substrates in a path that follows the interior perimeter of the surface edges. The volume of the adhesive may be sufficient to join both substrates, and may include a gap or edge (i.e., aperture) to dispose the medium mixture into the optical cell. The pre-sealed optical recording cell sustain structural integrity sufficient to sustain a substantially parallel orientation of the substrates while allowing the recording cell to be filled with the medium mixture from the gap or edge.

The medium mixture may include a matrix precursor configured to polymerize to form a matrix polymer, along with a photoimageable system. In some embodiments, the matrix polymer can be referred to as a support matrix. The medium mixture is a usually a liquid at 20° C. After casting, matrix precursors typically polymerize approximately to completion to form the matrix polymer. The resulting composition, now referred to as a recording medium, is typically no longer a liquid at 20° C. The recording medium is usually a solid or elastomer at 20° C. and includes a photoimageable system as described herein, along with the matrix polymer. Typically, but not necessarily, medium mixture embodiments include matrix precursors such as a polyol and an isocyanate, polymerization of which results in a matrix polymer comprising a polyurethane.

Recording medium embodiments can include a matrix polymer formed by polymerization of one or more matrix precursors, and a photoimageable system configured to form a photopolymer upon light induced polymerization. The photoimageable system may comprise a photoactive monomer and an initiator, and the matrix polymer typically comprises a cross-linked support matrix. In some embodiments, the photoimageable system further comprises a terminator. The matrix precursor and the photoimageable system (or the polymers generated therefrom) are typically compatible with each other, and thus avoid phase separation before or after polymerization of either of the matrix precursor or the photoimageable system. The matrix precursor and photoimageable systems furthermore polymerize by reactions sufficiently independent from each other that the photoimageable system remains photosensitive after formation of the matrix polymer but prior to exposure to photoinitiating light. Polymerization of the matrix precursors typically, but not necessarily, commences at room temperature (i.e., at approximately 20° C.) upon mixing of all medium mixture components. In some cases, dispersion of the polymerized medium mixture may include distributive deviations throughout the optical recording cell (e.g., resulting in thickness and/or parallelism variation). The resulting deviation can be determined by determining an optical path length (OPL) variance across the recording cell. As a result, the OPL variance may be compensated for prior to introduction of recording beams at the recording medium.

One or more coupling elements may be oriented with reference to the optical recording cell, including the polymerized recording medium inset between the substrates of the optical recording cell. The one or more coupling elements may promote the introduction of recording beams at the recording medium at one or more angular ranges exceeding the total internal reflection (TIR) angular range of the optical recording cell. Additionally, the optical means of the recording beams may be translated and/or rotated with respect to the recording medium to achieve hologram recording characteristics which exceed static implementation.

In some cases, the optical recording cell may be sandwiched between the one or more coupling elements with small amounts of fluid at the glass-to-glass interface. The fluid may be index-matched to the refractive index of each of the coupling elements, subject to a wavelength or range of wavelengths of the recording beams for hologram recording. The optical recording cell may be oriented as to substantially place the recording medium within a common surface region of each of the coupling elements.

In other cases, the coupling elements may be oriented and structured such that a reservoir structure may be disposed between the two coupling elements, either directly or subject to one or more glass surface planes to which the coupling elements are adhered. The surface planes may be substantially parallel, and each of the coupling elements may be mounted at the surface center of the planes. In some cases, the reservoir structure may include a sealing edge or chamber for sustaining material properties of the reservoir. The reservoir structure may be filled with a fluid index-matched to the refractive index of each of the coupling elements, subject to a wavelength or range of wavelengths of the recording beams for hologram recording. Prior to the hologram recording process, the recording medium may be at least partially submerged within the residing index-matched fluid of the disposed reservoir.

Methods for increasing throughput and efficiency of hologram programming at a recording media may include motorized stages implemented at the optical recording cell and/or motorized stages implemented at the substrates of the corresponding coupling elements, surface planes, and/or reservoir regions. The motorized stages may promote lateral and longitudinal translation of optical elements to obtain desired recording beam and recording medium portions. In some cases, employed motorized stages may allow for simultaneously recording multiple holograms for a plurality of optical recording cells, as part of a hologram array.

After hologram recording is complete, a the polymerized recording medium of an optical recording cell may be treated with spatially and/or temporally incoherent light. Spatial incoherence may correspond to a lack of correlation between distinct points, in the extent of one or more mode waveforms. Temporal incoherence may correspond to a lack of correlation at a single reference point during disparate temporal instances. The spatially and/or temporally incoherent light may substantially eliminate photosensitivity of the photopolymer precursors contained within the recording medium. The holography programmed (i.e., inclusion of hologram recordings) optical recording cell, including the treated recording medium, may be referred to as a holographic optical element.

One or more holographic optical element type components or devices may be employed in a light coupling device (e.g., an input coupler, an output coupler, and/or a cross coupler). Utilizing holographic optical element technology in the one or more light coupling devices may improve viewing capability and optical clarity of an associated image projection. A holographic optical element type device may exhibit achromatic characteristics. A holographic optical element type device (e.g., an output coupler embodiment) may be Bragg-mismatched to one reflection of TIR mode input light that is reflected between substrates and to input light passing straight through the holographic optical element type device (e.g., external light incident on a substrate). The hologram recordings may be configured to reflect light, of a wavelength, about a reflective axis offset from surface normal of the structure, at a plurality of particular incident angles. Aspects of the disclosure are further illustrated by and described with reference to apparatus diagrams, system diagrams, and flowcharts that relate to manufacturing holographic optical elements.

The aforementioned description provides examples, and is not intended to limit the scope, applicability or configuration of implementations of the principles described herein. Rather, the ensuing description will provide those skilled in the art with an enabling description for implementing implementations of the principles described herein. Various changes may be made in the function and arrangement of elements.

Thus, various implementations may omit, substitute, or add various procedures or components as appropriate. For instance, it should be appreciated that the methods may be performed in an order different than that described, and that various steps may be added, omitted or combined. Also, aspects and elements described with respect to certain implementations may be combined in various other implementations. It should also be appreciated that the following systems, methods, devices, and software may individually or collectively be components of a larger system, wherein other procedures may take precedence over or otherwise modify their application.

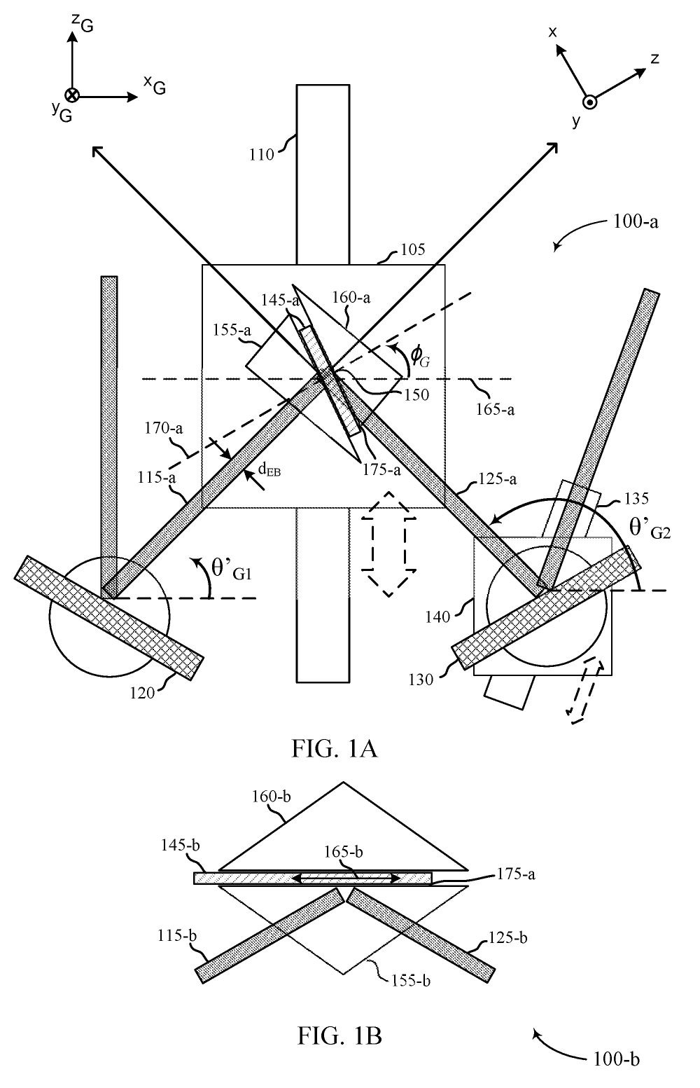

FIG. 1A illustrates a system 100-a for manufacturing a holographic optical element in accordance with various aspects of the disclosure. System 100-a may include a sample stage carrier 105, a sample carrier rail 110, a first recording beam 115-a, a signal mirror 120, a second recording beam 125-a, a reference mirror 130, a reference mirror carrier rail 135, a reference mirror carrier 140, a recording medium 145-a, a hologram 150, a first coupling element 155-a, and a second coupling element 160-a.

System 100-a may include global coordinates (xG, yG, zG) and holographic optical element coordinates (x, y, z). The origin may be defined to be in the center of the recording medium 145-a. In some cases, the recording medium 145-a may comprise a generally rectangular shape where ‘z’ corresponds to the thickness of the recording medium 145-a, ‘x’ corresponds to the length of the in-plane side of the recording medium 145-a, and ‘y’ corresponds to the length of the in-plane side of the recording medium 145-a. The global angle for recording, θG, may be defined as the angle of the first recording beam 115-a with respect to the xG-axis inside recording medium 145-a. Holographic optical element coordinates (x, y, z) may be converted to global coordinates by the following equation:

$$[ \begin{matrix}{x}_{G} \\ {y}_{G} \\ {z}_{G}\end{matrix} ] = [ \begin{matrix}sin {φ}_{G} & 0 & cos {φ}_{G} \\ 0 & - 1 & 0 \\ cos {φ}_{G} & 0 & - sin {φ}_{G}\end{matrix} ] [ \begin{matrix}x \\ y \\ z\end{matrix} ] \qquad ( 8 )$$

In an implementation, the system 100-a may dispose rotating mirrors such as the signal mirror 120 and the reference mirror 130 to create the correct angles for the first recording beam 115-a and the second recording beam 125-a. The angle of the signal mirror 120 may be changed to produce a desired angle (θG1) of first recording beam 115-a with width ˜dEB. The sample stage carrier 105 and the reference mirror carrier 140 may be positioned so as to illuminate the correct location with the recording beams for each exposure. The sample stage carrier 105 of the system 100-a may be positioned on the sample carrier rail 110 to facilitate the illumination of the recording medium 145-a with the first recording beam 115-a in the desired location. The reference mirror carrier 140 may be positioned on the reference mirror carrier rail 135 to facilitate the illumination of the recording medium 145-a with the second recording beam 125-a in the desired location. The recording medium 145-a may be referred to as a recording medium prior to or during hologram recording, and may include a photopolymer. In some embodiments, the recording medium may comprise photorefractive crystals, dichromatic gelatin, photo-thermo-refractive glass, and/or film containing dispersed silver halide particles. In some cases, the medium mixture may include mostly unreacted support matrix precursors including at least polyol and isocyanate.

With the rotation of the signal mirror 120 and the reference mirror 130 set, the mirrors may be arranged to direct the first recording beam 115-a and the second recording beam 125-a such that the recording beams intersect and interfere with each other to form an interference pattern that is recorded as a hologram 150 in the recording medium 145-a. The system 100-a may form multiple hologram recordings, each configured to reflect light of a particular wavelength about the skew axis 125-a at a plurality of incidence angles. Each hologram may be formed by an exposure of the recording medium 145-a to coherent light having a particular wavelength. The plurality of incidence angles corresponding to each hologram may be offset from one another by a minimum range of angles.

In some implementations, the recording beams may have widths that differ from each other, or they may be the same. The recording beams may each have the same intensity as each other, or intensity can differ among the beams. The intensity of the beams may be non-uniform. The recording medium 145-a may be secured in place between the first coupling element 155-a (e.g., a first prism) and the second coupling element 160-a (e.g., a second prism) using a fluid 175-a at the glass-to-glass interfaces of the recording medium 145-a with first coupling element 155-a and the second coupling element 160-a. The fluid 175-a may be index-matched to one or more of the coupling elements and the recording medium substrates. A skew axis 125-a resides at a skew angle relative to the surface normal 170-a. As depicted in FIG. 1A, skew angle may be −30.25 degrees relative to the surface normal 170-a. The angle between the first and second recording beams may reside in a range from 0 to 180 degrees. The recorded skew angle relative to surface normal 170-a then becomes ϕ′=(θ_{R1}+θ_{R2}−180°)/2+ϕ_{G} for in-plane system 100-a. For the nominal case where θ_{G2}=180°−θ_{G1}, ϕ′=ϕ_{G}. In FIG. 1A, ϕ_{G} shows the nominal skew angle relative to surface normal. Additionally, in FIG. 1A, the exact depiction of angles of θ_{G1} and θ_{G2} are not shown. The angles of θ′_{G1} and θ′_{G2} are illustrated and correspond to the angles of θ_{G1} and θ_{G2}. The angles of θ_{G1} and θ_{G2} are in relation to the first recording beam 115-a and the second recording beam 125-a beam, respectively, within the first coupling element 155-a and the second coupling element 160-a. The angles of θ′_{G1} and θ′_{G2} will be different from angles of θ_{G1} and θ_{G2} because of an index of refraction mismatch at the boundary between air and the coupling elements when the recording beams enter the coupling elements (e.g., the effects of Snell's Law or the law of refraction).

The first recording beam 115-a and the second recording beam 125-a may be nominally symmetrical about the skew axis 125-a such that the sum of first recording beam internal angle relative to the skew axis and the second recording beam internal angle relative to the skew axis equates to 180 degrees. Each of the first and second recording beams may be collimated plane wave beams originating from a laser light source.

Refraction at air/coupling element boundaries, for example where the first recording beam 115-a intersects an air/coupling element boundary of the first coupling element 155-a and where the second recording beam 125-a intersects an air/coupling element boundary of the second coupling element 160-a, is shown figuratively rather than strictly quantitatively. Refraction at the coupling element/recording medium boundary may also occur. In implementations, the recording medium and coupling elements each have an index of refraction of approximately 1.5471 at the recording beam wavelength of 405 nm.

A skew angle for a hologram (including a mean skew angle for a collection of holograms) can be substantially identical to a reflective axis angle, meaning the skew angle or mean skew angle is within 1.0 degree of the reflective axis angle. Given the benefit of the present disclosure, persons skilled in the art will recognize that the skew angle and reflective axis angle can be theoretically identical. However, due to limits in system precision and accuracy, shrinkage of recording medium that occurs during recording holograms, and other sources of error, the skew angle or mean skew angle as measured or estimated based on recording beam angles may not perfectly match the reflective axis angle as measured by incidence angles and reflection angles of light reflected by a holographic optical element. Nevertheless, a skew angle determined based on recording beam angles can be within 1.0 degree of the reflective axis angle determined based on angles of incident light and its reflection, even where medium shrinkage and system imperfections contribute to errors in estimating skew angle and reflective axis angle. It is understood that these medium shrinkage and system imperfections can be made arbitrarily small in the manufacture of holographic optical elements. In this regard, these medium shrinkage and system imperfections may be considered analogous to flatness of an ordinary or conventional mirror. In some examples, a fundamental limit associated with the manufacture of holographic optical elements using volume holograms may be based on thickness of the recording medium.

A skew axis/reflective axis is generally called a skew axis when referring to making a holographic optical element (for example when describing recording a hologram in a recording medium), and as a reflective axis when referring to light reflective properties of a holographic optical element. A skew angle for a hologram (including a mean skew angle for a collection of holograms) can be substantially identical to a reflective axis angle, meaning the skew angle or mean skew angle is within 1.0 degree of the reflective axis angle. Persons skilled in the art given the benefit of the present disclosure will recognize that the skew angle and reflective axis angle can be theoretically identical. However, due to limits in system precision and accuracy, shrinkage of recording medium that occurs during recording holograms, and other sources of error, the skew angle or mean skew angle as measured or estimated based on recording beam angles may not perfectly match the reflective axis angle as measured by incidence angles and reflection angles of light reflected by a holographic optical element. Nevertheless, a skew angle determined based on recording beam angles can be within 1.0 degree of the reflective axis angle determined based on angles of incident light and its reflection, even where medium shrinkage and system imperfections contribute to errors in estimating skew angle and reflective axis angle. Given the benefit of the present disclosure, persons skilled in the art will recognize that the skew angle for a given hologram is the same as the grating vector angle for that hologram.

In a variation of the system 100-a, a variable wavelength laser may be used to vary the wavelength of the first and second recording beams. Incidence angles of the first and second recording beams may be, but are not necessarily, held constant while the wavelength of the first and second recording beams is changed. Wavelengths may be comprised of visible red light wavelength, visible blue light wavelength, visible green light wavelength, ultraviolet (UV) wavelength, and/or infrared (IR) wavelength. Each hologram of the system 100-a may reflect an incidence angle at a wavelength that is different than another hologram recording. The system 100-a may have reflective properties that allow it to reflect light at a substantially different wavelength, and in particular a considerably longer wavelength, than the recording beam wavelength.

FIG. 1B illustrates a system 100-b for manufacturing a holographic optical element in accordance with various aspects of the disclosure. System 100-b may include a first recording beam 115-b, a second recording beam 125-b, a recording medium 145-b, a first coupling element 155-b, a second coupling element 160-b, and skew axis 125-b. System 100-b may be an expanded view in reference to embodiments discussed in reference to FIG. 1A.

In some cases, one or more holographic optical elements may be fabricated for a light coupling device. A holographic optical element disposed in a horizontal waveguide of a light coupling device may be referred to as a cross coupler. Alternatively, a holographic optical element disposed in a vertical waveguide of a light coupling device may be referred to as an output coupler. In some cases, each reflective axis of the disposed holographic optical elements may be either parallel or angularly offset to the surfaces of the one or more waveguides. For example, a cross coupler having a crossed holographic optical element cross coupler configuration may be fabricated by re-orienting the recording medium 145-b within the first coupling element 155-b (e.g., a first prism) and the second coupling element 160-b (e.g., a second prism). A fluid 175-a may be utilized at the glass-to-glass interfaces of the recording medium 145-b with the first coupling element 155-b and/or the second coupling element 160-b. The fluid 175-a may be index-matched to both the coupling elements and the recording medium. In some recording implementations, the second coupling element 160-b may be omitted and replaced with a component for securing or stabilizing the recording medium 145-b. The component for securing or stabilizing the recording medium 145-b that may also include light absorbing characteristics. For example, the first recording beam 115-b and the second recording beam 125-b may both enter the first coupling element 155-b when configuring a cross coupler.

In some cases, a second holographic optical element orientation may be recorded on the re-oriented recording medium 145-b. The second holographic optical element may be oriented in an at least partially overlapping, or non-overlapping manner with the first holographic optical element. Thus, a cross holographic optical element configuration is formed in a given volume of the recording medium 145-b (i.e., the recording medium after reorienting and curing processes). The re-orienting process may be repeated to record all desired skew axes of the light coupling device. In some cases, the second skew holographic optical element may be oriented in a non-overlapping manner with the first holographic optical element.

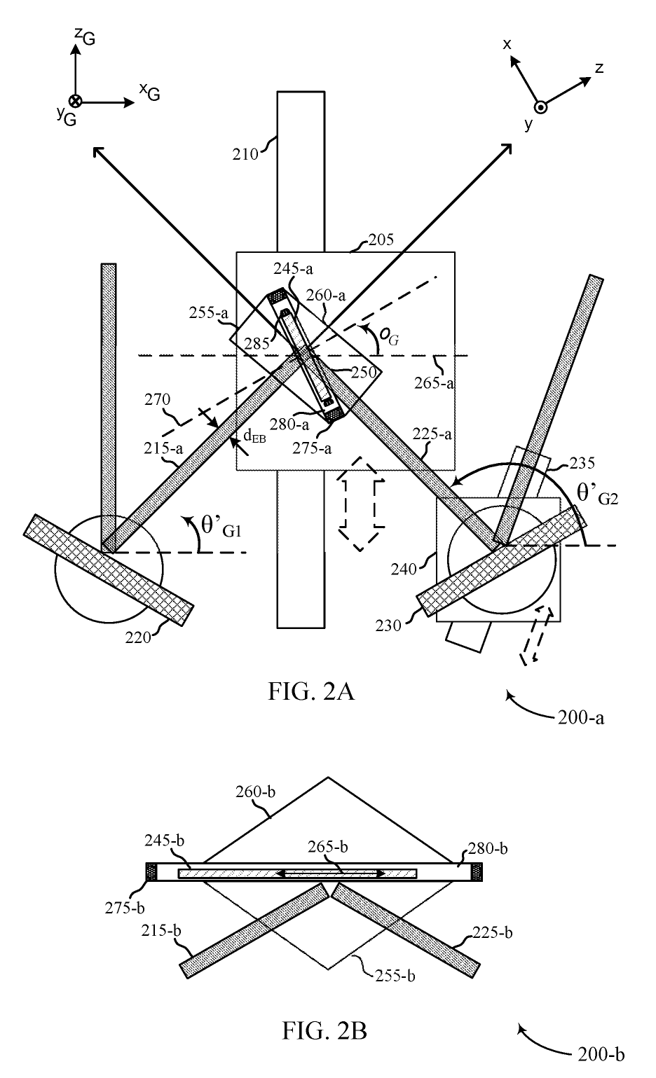

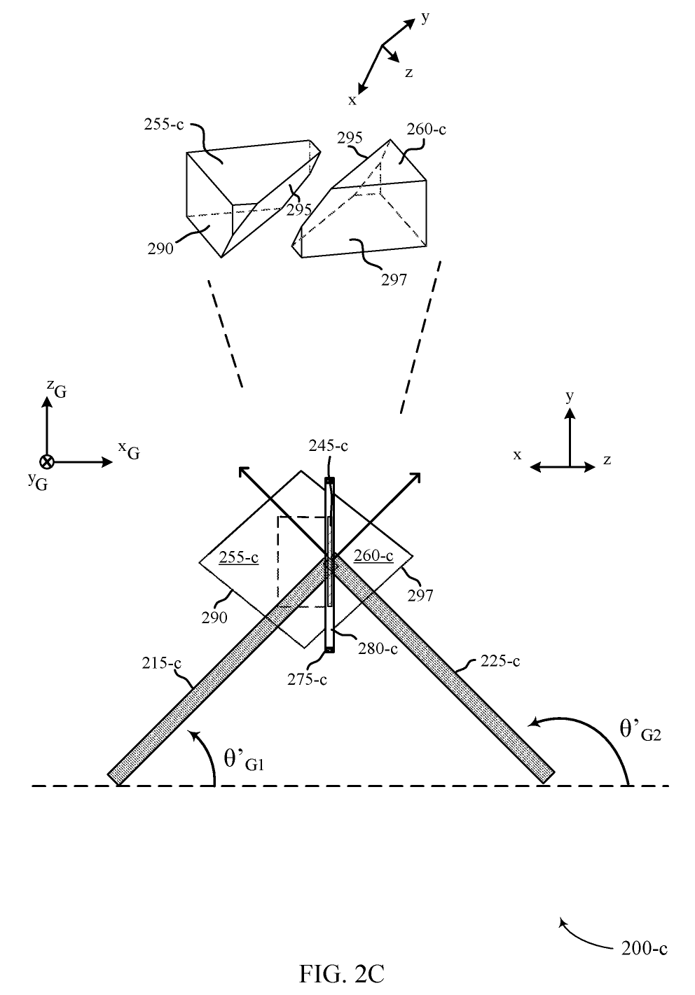

FIG. 2A illustrates a system 200-a for manufacturing a holographic optical element in accordance with various aspects of the disclosure. System 200-a may include a sample stage carrier 205, a sample carrier rail 210, a first recording beam 215, a signal mirror 220, a second recording beam 225, a reference mirror 230, a reference mirror carrier rail 235, a reference mirror carrier 240, a recording medium 245, a hologram 250, a first coupling element 255-a, and a second coupling element 260-a. Reservoir 275-a may be disposed between the first coupling element 255-a (e.g., first prism) and the second coupling element 260-a (e.g., second prism). In some cases, reservoir 275-a may be a generally rigid structure with respect to the coupling elements 255-a and 260-a, as shown. In other cases, reservoir 275-a may span a volume extending beyond the coupling elements 255-a and 260-a to which the coupling elements 255-a and 260-a are oriented and adhered at substrates of the reservoir 275. In some cases, reservoir 275-a may include a sealing edge or chamber for sustaining material properties. The sealing edge or chamber may exhibit pliability subject to a force exhibited by coupling element 255-a and/or coupling element 260-a. For example, one or more actuators may be used to exert the force to coupling element 255-a and/or coupling element 260-a. Reservoir 275-a may be filled with a fluid 280-a, the fluid may be index-matched to the refractive index of each of the recording medium substrates 255-a and 260-a at a range of wavelengths. Recording medium 245-a may be at least partially submerged within the index-matched fluid 280-a of reservoir 275. In some cases recording medium 245-a may be substantially parallel to the proximal substrates of at least one of coupling elements 255-a and 260-a. In other cases, recording medium 245-a may be translated according to a lateral and/or longitudinal offset from center orientation of the reservoir 275-a, according to the inset orientation axis and/or angularly offset from the proximate substrates of at least one of coupling elements 255-a and 260-a.

In an implementation, the system 200-a may dispose rotating mirrors such as the signal mirror 220 and the reference mirror 230 to create the correct angles for the first recording beam 215-a and the second recording beam 225. The angle of the signal mirror 220 may be changed to produce a desired angle (θG1) of first recording beam 215-a with width ˜dEB. The sample stage carrier 205 and the reference mirror carrier 240 may be positioned so as to illuminate the correct location with the recording beams for each exposure. The sample stage carrier 205 of the system 200-a may be positioned on the sample carrier rail 210 to facilitate the illumination of the first recording beam 215-a through coupling element 255-a, the index-matched fluid 280-a resident at reservoir 275-a, and incident at the recording medium 245, in the desired location. The reference mirror carrier 240 may be positioned on the reference mirror carrier rail 235 to facilitate the illumination of the second recording beam 225-a through coupling element 255-a, the index-matched fluid 280-a resident at reservoir 275-a, and incident at the recording medium 245, in the desired location. The recording medium 245-a and may include a polymerized photopolymer that includes substantially unreacted photopolymer precursors. In some embodiments, the recording medium may comprise photorefractive crystals, dichromatic gelatin, photo-thermo-refractive glass, and/or film containing dispersed silver halide particles. In some cases, the medium mixture may include mostly unreacted support matrix precursors including at least polyol and isocyanate.

With the rotation of the signal mirror 220 and the reference mirror 230 set, the mirrors may be arranged to direct the first recording beam 215-a and the second recording beam 225-a such that the recording beams intersect and interfere with each other to form an interference pattern that is recorded as a hologram 250 in the recording medium 245. The system 200-a may form multiple hologram recordings, each configured to reflect light of a particular wavelength about the skew axis 225-a at a plurality of incidence angles. Each hologram may be formed using an exposure of the recording medium 245-a to coherent light having a particular wavelength.

In some implementations, the recording beams may have widths that differ from each other, or they may be the same. The recording beams may each have the same intensity as each other, or intensity can differ among the beams. The intensity of the beams may be non-uniform. The recording medium 245-a may inset within reservoir 275-a disposed between first light coupling device 255-a and second light coupling device 260-a. Recording medium 245-a may be at least partially submerged within a fluid 280-a contained within reservoir 275-a. The fluid may be index-matched to both the coupling elements 255-a and 260-a and the recording medium 245. A skew axis 225-a resides at a skew angle relative to the surface normal 270. The angle between the first and second recording beams may reside in a range from 0 to 180 degrees. The recorded skew angle relative to surface normal 270 then becomes ϕ′=(θ_{R1}+θ_{R2}−180°)/2+θ_{G} for in-plane system 200-a. For the nominal case where θ_{G2}=180°−θ_{G1}, ϕ′=ϕ_{G}. In FIG. 2, ϕ_{G} shows the nominal skew angle relative to surface normal. Additionally, in FIG. 2, the exact depiction of angles of θₘ and θ_{G2} are not shown. The angles of θ′_{G1} and θ′_{G2} are illustrated and correspond to the angles of θ_{G1} and θ_{G2}. The angles of θ_{G1} and θ_{G2} are in relation to the first recording beam 215-a and the second recording beam 225, respectively, within the first coupling element 255-a and the second coupling element 260-a. The angles of θ′_{G1} and θ′_{G2} will be different from angles of θ_{G1} and θ_{G2} because of an index of refraction mismatch at the boundary between air and the coupling elements when the recording beams enter the coupling elements (e.g., the effects of Snell's Law or the law of refraction).

Refraction at air/coupling element boundaries, for example where the first recording beam 215-a intersects an air/coupling element boundary of the first coupling element 255-a and where the second recording beam 225-a intersects an air/coupling element boundary of the second coupling element 260-a, is shown figuratively rather than strictly quantitatively. Index-matched fluid 280-a may be substantially matched to at least one of the first coupling element 255-a and the second coupling element 260-a. The index-matched fluid 280-a may be classified according to an index of refraction of the fluid being within a variant threshold of the index of refraction of the respective coupling element. For example, in some embodiments, the index-matched fluid may have an index of refraction, at a specified wavelength or range of wavelengths, within 0.10 of the index of refraction of the corresponding coupling element (e.g., first coupling element 255-a, second coupling element 260-a), and classified as “matched” to the coupling element. In other embodiments, the index-matched fluid may have an index of refraction, at a specified wavelength or range of wavelengths, within 0.025 of the index of refraction of the corresponding coupling element (e.g., first coupling element 255-a, second coupling element 260-a), and classified as “closely matched” to the coupling element. Furthermore, in other cases, the index-matched fluid may have an index of refraction, at a specified wavelength or range of wavelengths, within 0.010 of the index of refraction of the corresponding coupling element (e.g., first coupling element 255-a, second coupling element 260-a), and classified as “very closely matched” to the coupling element. The classification parameters provided are not intended to be exclusionary, rather they are provided as examples of index-matched fluid characterization. Incident light passing from the coupling elements 255-a and/or 260-a to recording medium 245-a may be refracted. Additionally or alternatively, refraction may occur at the boundary between a substrate of the recording cell and contained recording medium 245-a of the recording cell. In implementations, the recording medium and coupling elements each have an index of refraction of approximately 1.5302, the substrates of the recording cells have an index of 1.5225, the index-matched fluid 280-a has an index between 1.5302 and 1.5225, at the recording beam wavelength of 405 nm. Optionally, the refractive index of the fluid may be 1.5263, which is between the refractive index of the recording medium substrate and the refractive index of the coupling element.

Mechanical mounts 285 may be integrated with an optical recording cell containing recording medium 245. The mechanical mounts may include a clamp or fastener mechanism to hold the recording medium 245, while sustaining stability and characteristic properties (e.g., parallelism) of the recording medium 245, and surrounding substrates contained within the optical recording cell. A motorized stage and/or robotic mechanism may be implemented with the mounts 285 to translate and/or rotate the optical recording cell within the reservoir 275-a, for subsequent hologram recording at recording medium 245. Translation of the optical recording cell may include a lateral or longitudinal offset of the optical recording cell within reservoir 275-a, to position recording medium 245-a at an orientation between coupling elements 255-a and 260-a for subsequent hologram recording.

FIG. 2B illustrates a system 200-b for manufacturing a holographic optical element in accordance with various aspects of the disclosure. System 200-b may include a first recording beam 215-b, a second recording beam 225-b, a recording medium 245-b contained within a reservoir 275-b, disposed between a first coupling element 255-b and a second coupling element 260-b, and a skew axis 225-b. The one or more substrates of an optical recording cell, including recording medium 245-b, may be at least partially submerged in an index matched fluid 280-b contained within reservoir 275-b. System 200-b may be an expanded view in reference to embodiments discussed in reference to FIG. 2A.

In some cases, reservoir 275-b may extend beyond the surface area of at least one of coupling elements 255-b (e.g., first prism) and 260-b (e.g., second prism). Coupling elements 255-b and 260-b may be oriented and attached to substrate planes of the reservoir 275-b for subsequent hologram recording at the at least partially submerged recording medium 245-b. Via emission of the recording beams 215-b and 225-b, one or more holograms may be programmed at recording medium 245-b and one or more holographic optical elements may be fabricated at the optical recording cell containing at least recording medium 245-b. In some cases, each reflective axis of the disposed holographic optical elements may be either parallel or angularly offset to the surfaces of reservoir 275-b and/or the proximal planar edges of coupling elements 255-b and 260-b.

In some cases, a second holographic optical element orientation may be recorded on the re-oriented recording medium 245-b. The second holographic optical element may be oriented in an at least partially overlapping, or non-overlapping manner with the first holographic optical element. Thus, a cross holographic optical element configuration is formed in a given volume of the recording medium 245-b (i.e., the recording medium after reorienting and curing processes). The re-orienting process may be repeated to record all desired skew axes of the light coupling device. In some cases, the second skew holographic optical element may be oriented in a non-overlapping manner with the first holographic optical element.

FIG. 2C illustrates additional aspects of system 200-c for manufacturing a holographic optical element using tiger coupling elements, in accordance with various aspects of the disclosure. System 200-c may include first recording beam 215-c, second recording beam 225-c, recording medium 245-c, first coupling element 255-c, and second coupling element 260-c. Recording medium 245-c may be contained within a reservoir 275-c disposed between first coupling element 255-c and second coupling element 260-c. The one or more substrates of an optical recording cell, including recording medium 245-c, may be at least partially submerged in an index matched fluid 280-c contained within reservoir 275-c. The first recording beam 215-c, second recording beam 225-c, recording medium 245-c may be similar (but are not necessarily required to be identical) to these same numbered elements described with respect to FIG. 2B. In some embodiments, manufacturing holographic optical elements may include the method and configurations as described in reference to FIG. 2A. System 200-c may likewise include global coordinates (x_{G}, y_{G}, z_{G}) and holographic optical element coordinates (x, y, z). In some examples, first coupling element 255-c and second coupling element 260-c may be an example of tiger (total internal grazing-extension rotation) prisms (e.g., oblique-faced prisms) coupling elements or the like. In some cases, first coupling element 255-c may “overhang” second coupling element 260-c and recording medium 245-c. In other examples, second coupling element 260-c may “undercut” first coupling element 255-c and recording medium 245-c. First coupling element 255-c and second coupling element 260-c may each have a surface that is oblique to the base of the coupling element and form an angle of ϕ_{G} with respect to the y_{G}-axis. That is, first coupling element 255-c and second coupling element 260-c may allow recording medium 245-c surface normal to be angled by ϕ_{G} out of the plane. First coupling element 255-c and second coupling element 260-c may allow the recording medium 245-c to be rotated −90° about the x_{G}-axis compared to FIG. 2A in order to “split the difference” between the first recording beam 215-c and second recording beam 225-c angles.

The bottom portion of FIG. 2C illustrates a collapsed plane plan view (i.e., the x and z planes shown in the same plane) of the recording medium 245-c to more clearly show aspects associated with or resulting from the oblique orientation of the recording medium 245-c within the tiger coupling element configuration. A perspective view of the first coupling element 255-c and second coupling element 260-c with perspective view coordinates is illustrated above the collapsed plane plan view of the recording medium 245-c. The first coupling element 255-c and second coupling element 260-c are spaced apart in the perspective view to show where the recording medium 245-c would be positioned in the tiger coupling element configuration. Reservoir 275-c may thus have a longitudinally angular shape.

As described herein, first coupling element 255-c and second coupling element 260-c may have coupling element faces that comprise the tiger coupling element configuration. For example, first coupling element 255-c may have a first coupling element face 285 that is oblique to the base of first coupling element 255-c and form an angle of ϕ_{G} with respect to the y_{G}-axis. First coupling element 255-c may also have a second coupling element face 290 where the first recording beam 215-c may enter the first coupling element 255-c. Second coupling element 260-c may have a third coupling element face 295 that is oblique to the base of the second coupling element 260-c and form an angle of ϕ_{G} with respect to the y_{G}-axis. Second coupling element 260-c may also have a fourth coupling element face 297 where the second recording beam 225-c may enter the second coupling element 260-c.

While the use of first coupling element 255-c and second 260-c (e.g., tiger coupling elements), may be used to write equivalent hologram recordings having grating vectors aligned with the x_{G}-axis, first coupling element 255-c and second coupling element 260-c may able to access lower recording beam difference angles, alpha, than are accessible with in-plane coupling elements. That is, first coupling element 255-c and second coupling element 260-c may be used to record holograms having a lower frequency than can be written using in-plane coupling elements (using recording beams having the same wavelength). In some cases, a different set of first coupling element 255-c and second 260-c may be used to record holograms having a different vector angle, i.e., a different skew axis. First coupling element 255-c and second coupling element 260-c may also be index matched to recording medium 245-c and may affect the ability to perform hologram programming.

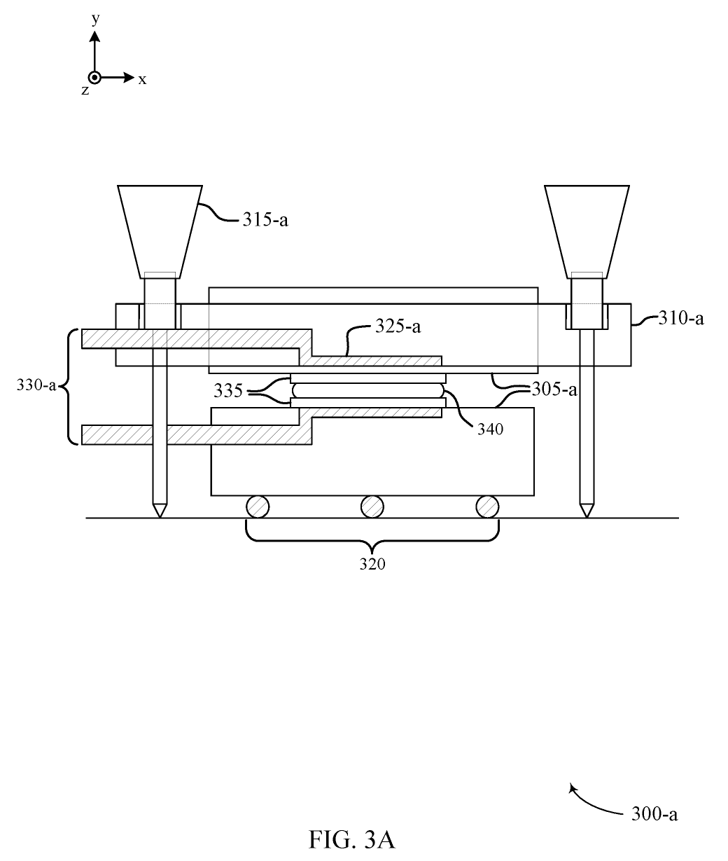

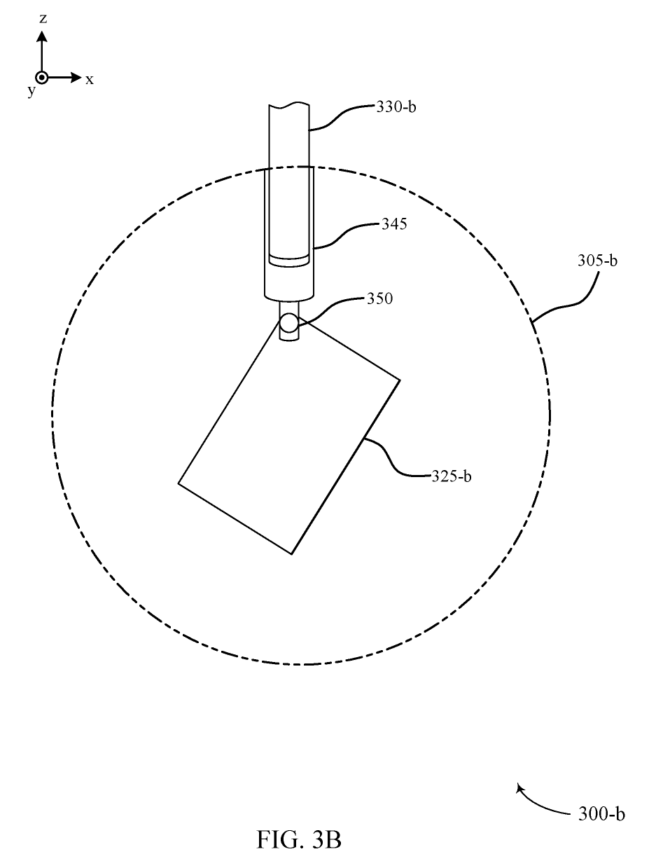

FIG. 3A illustrates a mechanical assembly 300-a for fabricating optical recording cells in association with manufacturing holographic optical elements, in accordance with various aspects of the present disclosure. The respective view (i.e., a side view) may correspond to a x,y planar region associated with the enclosed orientation axis of mechanical assembly 300-a.

Mechanical assembly 300-a may contain a pair of optical flats 305-a that are oriented and spaced according to a configuration of the mechanical assembly 300-a. A bottom flat of the pair of optical flats 305-a may rest on one or more bearings 320. A top flat of the pair of optical flats 305-a may be statically supported by a mount 310-a. In some embodiments, mount 310-a may be fixed by one or more fine measurement devices such as micrometers 315-a passed through apertures at the mount 310-a. The punctures may be evenly spaced and/or configured according to the mechanical assembly 300-a. Each of the micrometers 315-a may allow for adjustment of the mount 310-a to a variant spacing and/or orientation of the top flat of the pair of optical flats 305-a, with reference to the bottom flat of the pair of optical flats 305-a, to promote at least alignment and/or parallelism between the optical flats. Each of the micrometers may be adjusted uniformly, or at individual variants, promoting angular offset and/or orientation deviation at mount 310-a.

In other cases (not shown), a mechanism may be fastened to at least one of the pair of optical flats 305-a for adjustment of the mount 310-a to a variant spacing and/or orientation of the top flat of the pair of optical flats 305-a, with reference to the bottom flat of the pair of optical flats 305-a, to promote at least alignment and/or parallelism between the optical flats 305-a. In either case, additional components of the micrometers 315-a and/or the fastened mechanism may promote tip/tilt adjustment capability of the bottom flat of the pair of optical flats 305-a. Additionally or alternatively, one or more spacers (not shown) may be implemented at one or more of the pair of optical flats 305-a, to at least allow for variant adjustment of orientation and spacing between the pair of optical flats 305-a. One or more channels 325-a may be etched within the pair of optical flats 305-a and contain a set of hoses 330-a. Each of the hoses 330-a may provide a vacuum suction force at the respective duct structures for securing objects resting on the pair of optical flats 305-a.

A pair of substrates 335 may be cleaned and polished, and held in place by vacuum suction of the hoses 330-a. At least one of the substrates may contain an edge seal for optical cell composition. In some embodiments, a medium mixture 340 may be dispersed onto substrates 335 preemptively to sealing of the substrates 335, and fabrication of an optical recording cell. A mount of the mechanical assembly 300-a may dispense the medium mixture 340 onto at least one of the substrates 335. Micrometers 315-a and/or a fastened mechanism of the mechanical assembly 300-a may precisely adjust top optical flat toward bottom optical flat, registering a configured spacing between the substrates 335. The configured spacing may be correlated to the desired media thickness and allowing the medium mixture 340 to spread to fill the desired surface region. The substrates 335 may then be registered mechanically and/or visually for orientation displacement and the promotion of edge alignment and parallelism between the substrates of the constructed optical cell. A variant of the above-described method may include forgoing the implementation of micrometers 315-a at mechanical assembly 300-a, and adjusting the top optical flat toward the bottom optical flat up to a precisely configured distance determined by spacers between the pair of optical flats 305-a. The distance associated with the spacers may correlate to the desired media thickness, and allow the medium mixture to spread to fill the desired surface region of the substrates 335. Similarly, the substrates 335 may then be registered mechanically and/or visually for orientation displacement and the promotion of edge alignment and parallelism between the substrates of the constructed optical cell.

Alternatively, in other embodiments, substrates 335 may be cleaned and polished, and held in place by vacuum suction of the hoses 330-a. One or more micrometers 315-a, a fabricated mechanism, one or more spacers, or a combination therein, may adjust the top optical flat toward the bottom optical flat and seal the substrates 335 together prior to dispersion of media components. Adhesive and/or structural materials may be preemptively dispensed onto the substrates in a path that follows the interior perimeter of the surface edges. The volume of the adhesive may be sufficient to join both substrates, and may include at least one gap or edge (i.e., aperture) to dispose the medium mixture into the optical cell. In some cases, shims constructed from a variety of materials (e.g., glass, polymer) may be used in alternative to, or in combination with an adhesive material to create an interior perimeter of the optical recording cell, between the substrates 335. The shims may function as both a seal and a spacer of the optical recording cell. The pre-sealed optical recording cell sustain structural integrity sufficient to sustain a substantially parallel orientation of the substrates while allowing the recording cell to be filled with the medium mixture from the gap or edge.

The medium mixture 340 may include a matrix precursor configured to polymerize to form a matrix polymer, along with a photoimageable system. In some embodiments, the matrix polymer can be referred to as a support matrix. The medium mixture is a usually a liquid at 20° C. After casting, matrix precursors typically polymerize approximately to completion to form the matrix polymer. The resulting composition, now referred to as a recording medium, is typically no longer a liquid at 20° C. The recording medium is usually a solid or elastomer at 20° C. and includes a photoimageable system as described above, along with the matrix polymer. Typically, but not necessarily, medium mixture embodiments include matrix precursors such as a polyol and an isocyanate, polymerization of which results in a matrix polymer comprising a polyurethane.

Recording medium embodiments can include a matrix polymer formed by polymerization of one or more matrix precursors, and a photoimageable system configured to form a photopolymer upon light induced polymerization. The photoimageable system may comprise a photoactive monomer and an initiator, and the matrix polymer typically comprises a cross-linked support matrix. In some embodiments, the photoimageable system further comprises a terminator. The matrix precursor and the photoimageable system (or the polymers generated therefrom) are typically compatible with each other, and thus avoid phase separation before or after polymerization of either of the matrix precursor or the photoimageable system. The matrix precursor and photoimageable systems furthermore polymerize by reactions sufficiently independent from each other that the photoimageable system remains photosensitive after formation of the matrix polymer but prior to exposure to photoinitiating light. Polymerization of the matrix precursors is typically, but not necessarily, thermally initiated. After the matrix polymer is formed, the photopolymer may covalently bond to the matrix polymer upon light-induced polymerization of the photoimageable system.

FIG. 3B illustrates of a mechanical assembly 300-b for fabricating optical recording cells in association with manufacturing holographic optical elements, in accordance with various aspects of the present disclosure. Mechanical assembly 300-b may be an example of mechanical assembly 300-a, described with reference to FIG. 3A. The respective view (i.e., a top or bottom view depending on a light input configuration) may correspond to a x,z planar region associated with the enclosed orientation axis of mechanical assembly 300-a.

The thickness of optical flat 305-b, with reference to the pair of optical flats 305-a of FIG. 3A, may be correlated to the diameter of optical flat 305-b. In particular, the thickness of optical flat 305-b may be such that the amount of bending and/or stress at the optical flat 305-b is optically insignificant. For example, for a diameter of 4 inches, optical flat 305-b may have a thickness of 0.75 inches. The following example is not intended to be limiting, but rather to provide context for the determined thickness of an optical flat 305-b implemented within the mechanical assembly 300-b. One or more holes 345 may be provided into and/or through the optical flat 305-b. One or more hoses 330-b may be operatively coupled to the optical flat 305-b for applying vacuum suction. One or more additional holes 350 may be at least partially located with respect to a respective optical flat 305-b to connect the one or more hoses 330-b to the optical flat 305-b. The one or more hoses 330-b may be joined by a channel 325-b that has dimensions inset of the dimensionality of the substrates 335, with reference to FIG. 3A.

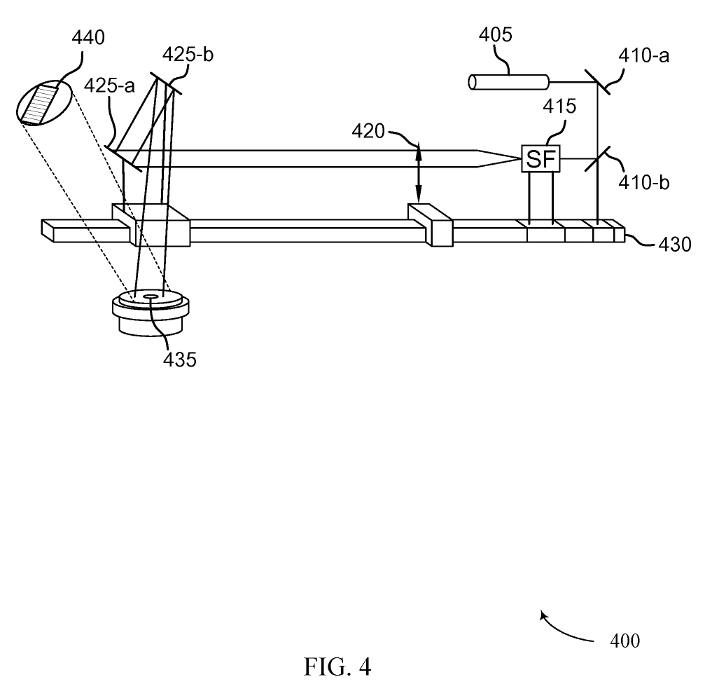

FIG. 4 illustrates an example of a rail interferometry system 400 that supports manufacturing holographic optical elements, in accordance with various aspects of the present disclosure. Rail interferometry system 400 may include a coherent light source 405, one or more alignment mirrors 410-a and 410-b, a spatial filter 415, a collimating lens 420, and one or more sliding mirrors 425-a,b oriented and mounted on a rail 430.

Rail interferometry system 400 may be used for adjusting the parallelism of substrates 335, with reference to FIG. 3A, during fabrication of recording media. Rail interferometry system 400 may provide benefits for properly fabricating an optical recording cell, particularly for fabrication methods which necessitate an extensive temporal duration to perform polymerization of a recording medium. Rail interferometry system 400, as displayed, may be an embodiment of an interferometry system that is partially mounted on the rail 430, such that interferometric techniques can be performed by reflections from significantly parallel surfaces of an optical device 435, that lies in the projected path of one or more propagating modes associated with light source 405 following collimation at collimating lens 420. Sliding mirrors 425-a and/or 425-b may move along the path of rail 430, and promote a targeted position of the collimated light along a parallel path of rail interferometry system 400. For an optical entity that is targeted by one or more modes of the collimated light, an interference pattern 440 may be formed from the reflections of the substantially parallel substrates (e.g., substrates 335 with reference to FIG. 3A). Interference pattern 440 may be projected onto a desired surface for display.

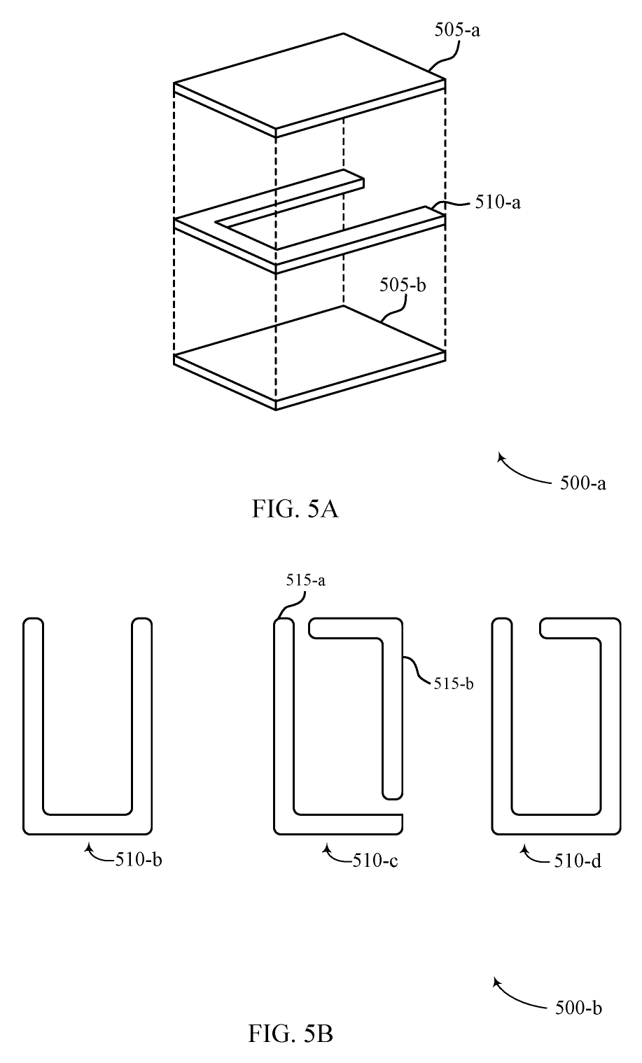

FIG. 5A illustrates an embodiment of a pre-sealed fabrication for an optical recording cell 500 that supports manufacturing holographic optical elements, in accordance with various aspects of the present disclosure. Optical recording cell 500 may represent methods and or features associated with pre-sealed optical recording cell fabrication, as described in FIGS. 2A, 2B, and 2C.

A middle layer (e.g., shim) 510-a may be implemented between a pair of substrates 505-a and 505-b for fabricating optical recording cell 500. Each of the substrates 505 may be characterized as “LCD grade” glass. Shim 510-a may contain one or more material combinations, including glass, epoxy, plastic, or UV-cure adhesive. In some cases, shim 510-a may be used in alternative to, or in combination with additional adhesive material to create an interior perimeter of the optical recording cell, between the substrates 505. Shim 510-a may function as both a seal and a spacer of the optical recording cell. The pre-sealed optical recording cell sustain structural integrity sufficient to sustain a substantially parallel orientation of the substrates 505. Shim 510-a may be constructed at a thickness substantially equivalent to a medium layer thickness configured for the fabricated optical recording cell 500. In some cases, one or more edges or surfaces of the shim 510-a may implement a homogenization substance or coating for enabling partial reflectivity of incident light (e.g., modes) of the recording cell 500.

FIG. 5B illustrates one or more embodiments 500-b of a middle layer (e.g., shim) implemented within a pre-sealed optical recording cell that supports manufacturing holographic optical elements, in accordance with various aspects of the present disclosure. Each of the one or more embodiments may support methods and features of shim 510-a, as described in FIG. 5A. As enumerated below, an edge may refer to a lateral component of a shim, with reference to a reference orientation of the shim and/or optical recording cell. Similarly, a surface may refer to a longitudinal component of a shim, with reference to a reference orientation of the shim and/or optical recording cell.

In some cases, a shim 510-b may span a pair of surfaces and a single edge. In particular embodiments, the surfaces may be substantially parallel. Additionally or alternatively, the edge may be adjacent to at least one of the pair of surfaces, and sustain orthogonal corners throughout the shim 510-b. A gap within shim 510-b may span an area substantially parallel to the material edge, and may span the length of the edge. The gap may be used as a port to fill the optical recording cell with media mixture. In other cases, a shim 510-c may include a pair of disparate material components 515-a and 515-b. Each of components 515-a and 515-b may include a single surface and a single edge. In some cases, the surface and edge of the respective component 515 may be adjacent, and sustain a single orthogonal corner. The components 515-a and 515-b may be laterally and/or longitudinally offset as a means to fabricate shim 510-c with a pair of openings (e.g., gaps). A first opening of the pair of openings may be used as a port to fill the optical recording cell with media mixture. A second, alternative opening of the pair of openings may operate to relieve pressure within the optical recording cell and/or dispose excess medium mixture as provided by the media fill. Furthermore, in other cases, a shim 510-c may span a pair of surfaces and a pair of edges. In particular embodiments, the surfaces may be substantially parallel. Additionally or alternatively, the edges may be substantially parallel and may be adjacent to at least one of the pair of surfaces, and sustain orthogonal corners throughout the shim 510-c. The edges of the shim 510-c may have varying lengths, such that the smaller edge of the pair of edges is only joined to a single surface of the shim 510-c. A gap within shim 510-c may span the excess area between the smaller edge of the pair of edges and the separate surface of the shim 510-c. The gap may be used as a port to fill the optical recording cell with media mixture.

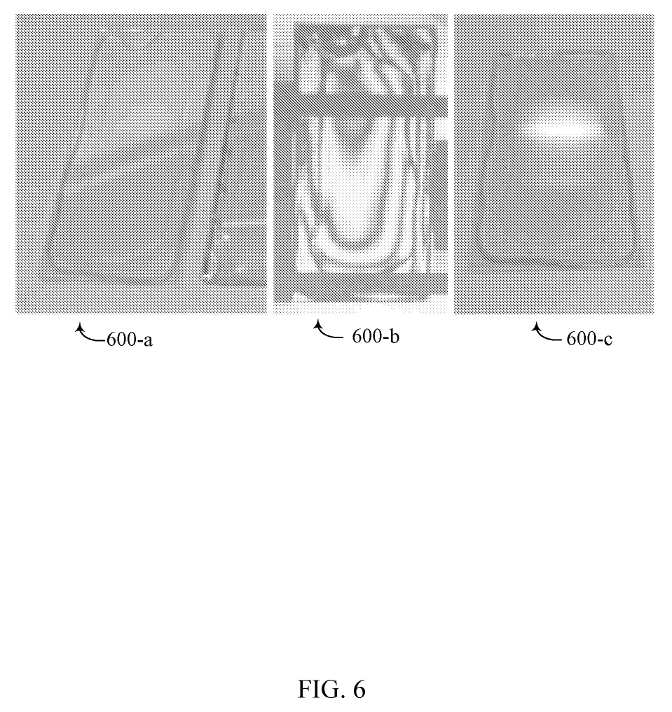

FIG. 6 illustrates pre-sealed optical recording cells 600-a, 600-b, and 600-c that support manufacturing holographic optical elements, in accordance with various aspects of the present disclosure. Each of the one or more embodiments may support methods and features of pre-sealed optical recording cells and their fabrication, with reference to FIGS. 2A-2C, 5A, and 5B.

Optical recording cell 600-a illustrates a pre-sealed optical cell fabrication including a middle layer implicit to the footprint of a dispersed adhesive between substrate components of the optical cells, and/or a surface material (e.g., shim) implemented between the pair of substrates for fabricating optical recording cell 600-a, and storing a dispersed medium mixture within the optical recording cell 600-a. Each of the substrates may be characterized as “LCD grade” glass. In some cases, the adhesive may be of volume sufficient to make contact with both substrates, and span a depth (i.e., thickness) sufficient to function as both a seal and a spacer of the optical recording cell. The adhesive may be of thickness correlated to a medium layer thickness configured for the fabricated optical recording cell 600-a. In other cases, the shim may function as both a seal and a spacer of the optical recording cell, and contain one or more material combinations, including glass, epoxy, plastic, or UV-cure adhesive. The shim may be constructed at a thickness substantially equivalent to a medium layer thickness configured for the fabricated optical recording cell 600-a. In some cases, a shim may be used in alternative to, or in combination with additional adhesive material to create an interior perimeter of the optical recording cell, between the substrates. The pre-sealed optical recording cell 600-a may sustain structural integrity sufficient to sustain a substantially parallel orientation of the substrates.

A medium mixture may be dispersed into optical recording cell 600-a via a gap and/or edge opening within the adhesive path and/or shim of optical recording cell 600-a. Configured spacing between substrates of optical recording cell 600-a, as well as sustained parallelism between substrates, may allow for the medium mixture spread to fill the desired surface region between the substrates. The medium mixture may include a matrix precursor configured to polymerize to form a matrix polymer, along with a photoimageable system. In some embodiments, the matrix polymer can be referred to as a support matrix. After casting, matrix precursors typically polymerize approximately to completion to form the matrix polymer, including a photoimageable system.

As shown in optical cell 600-b, deviations from parallelism, including the polymerized recording medium of the cell, may be determined by interrogating the optical path length (OPL) variance across the optical recording cell. Contrast regions of the recording medium (i.e., inset lines on fringe pattern of the recording medium as illustrated) may be indicative of at least a lack of dispersion uniformity of the recording medium within the optical cell 600-b. The OPL may be refer to the geometric length of promoted light incident at a medium, and the index of refraction of the medium through which the light (e.g., modes) propagate. The OPL may determine the phase of the modes and govern interference and diffraction of propagating modes. By interrogating the OPL variance throughout optical recording cell 600-b, including the recording medium, variances in dispersion uniformity may result in indicative phase shifts of propagating light emitted at the recording medium. In some cases, the OPL variance may be compensated for prior to introduction of recording beams at the recording medium.

One or more recording beams may then be introduced at optical recording cell 600-c, for hologram programming a the recording medium. One or more coupling elements may promote the introduction of recording beams at the recording medium, at one or more angular ranges exceeding the total internal reflection (TIR) angular range of the optical recording cell 600-c. Additionally, the optical means of the recording beams may be translated and/or rotated with respect to the orientation of the recording medium to achieve hologram recording characteristics which exceed static implementation. The optical means may form multiple hologram recordings, each configured to reflect light of a particular wavelength about a skew axis of the hologram recordings at a plurality of incidence angles. Each hologram recording may be formed using a plurality of exposures of the recording medium to coherent light having a particular wavelength. The plurality of incidence angles corresponding to each hologram recording may be offset from one another by a minimum range of angles.

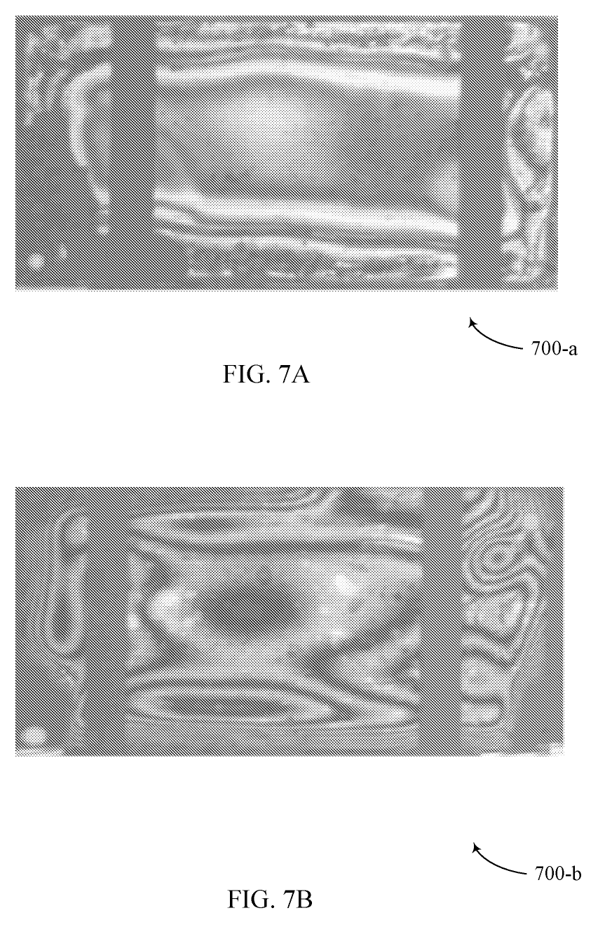

FIGS. 7A and 7B illustrate examples of pre-sealed optical recording cells 700-a and 700-b that support manufacturing holographic optical elements, in accordance with various aspects of the present disclosure. Each of the one or more embodiments may support methods and features of pre-sealed optical recording cells and their fabrication, with reference to FIGS. 2A-2C, 5A, and 5B as well as features of OPL variance determination as specified in FIG. 6B.

Each of optical recording cells 700-a and 700-b may display fringe pattern characteristics associated with interrogated OPL variance across the respective optical recording cells 700. Contrast regions of the recording medium (i.e., inset lines on the fringe pattern of recording medium as illustrated) may be indicative of at least a lack of dispersion uniformity of the recording medium within the respective optical cells 700-a and 700-b. The OPL may refer to the geometric length of promoted light incident at a medium, and the index of refraction of the medium through which the light (e.g., modes) propagate. The OPL may determine the phase of the modes and govern interference and diffraction of propagating modes. By interrogating the OPL variance throughout each of optical recording cells 700-a and 700-b including the recording medium, variances in dispersion uniformity as displayed in the inset fringe patterns may result in indicative phase shifts of propagating light emitted at the respective recording mediums. In some cases, the OPL variance may be compensated for prior to introduction of recording beams at the respective recording mediums.

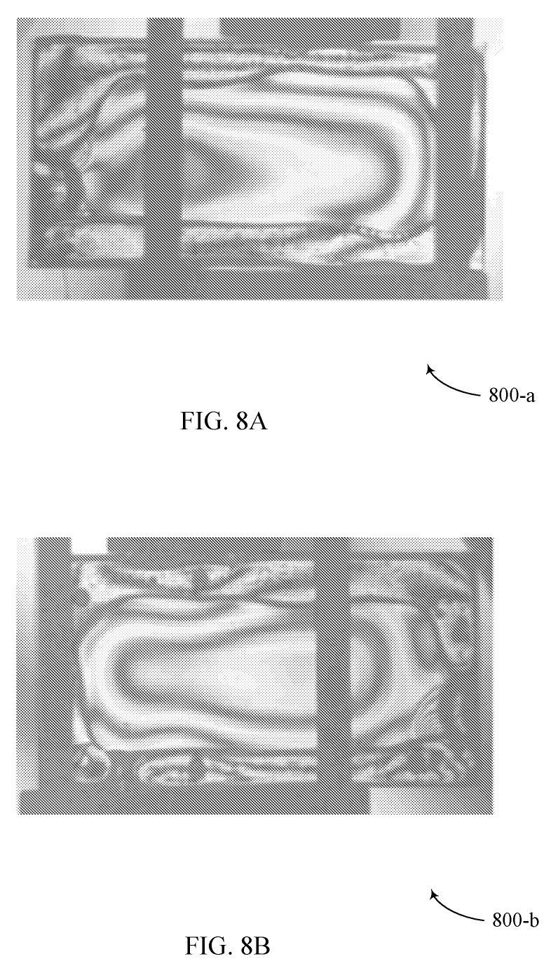

FIGS. 8A and 8B illustrate additional examples of pre-sealed optical recording cells 800-a and 800-b that support manufacturing holographic optical elements, in accordance with various aspects of the present disclosure. Each of the one or more embodiments may support methods and features of pre-sealed optical recording cells and their fabrication, with reference to FIGS. 2A-2C, 5A, and 5B, as well as features of OPL variance determination as specified in FIG. 6B.

Each of optical recording cells 800-a and 800-b may display fringe pattern characteristics associated with interrogated OPL variance across the respective optical recording cells 800. Contrast regions of the recording medium (i.e., inset lines on the fringe pattern of recording medium as illustrated) may be indicative of at least a lack of dispersion uniformity of the recording medium within the respective optical cells 800-a and 800-b. The OPL may refer to the geometric length of promoted light incident at a medium, and the index of refraction of the medium through which the light (e.g., modes) propagate. The OPL may determine the phase of the modes and govern interference and diffraction of propagating modes. By interrogating the OPL variance throughout each of optical recording cells 800-a and 800-b, including the recording medium, variances in dispersion uniformity as displayed in the inset fringe patterns may result in indicative phase shifts of propagating light emitted at the respective recording mediums. In some cases, the OPL variance may be compensated for prior to introduction of recording beams at the respective recording mediums.

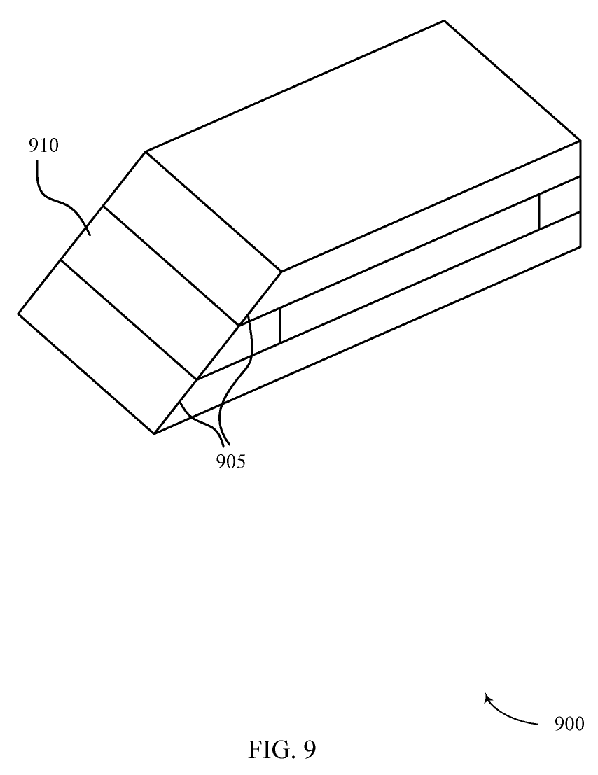

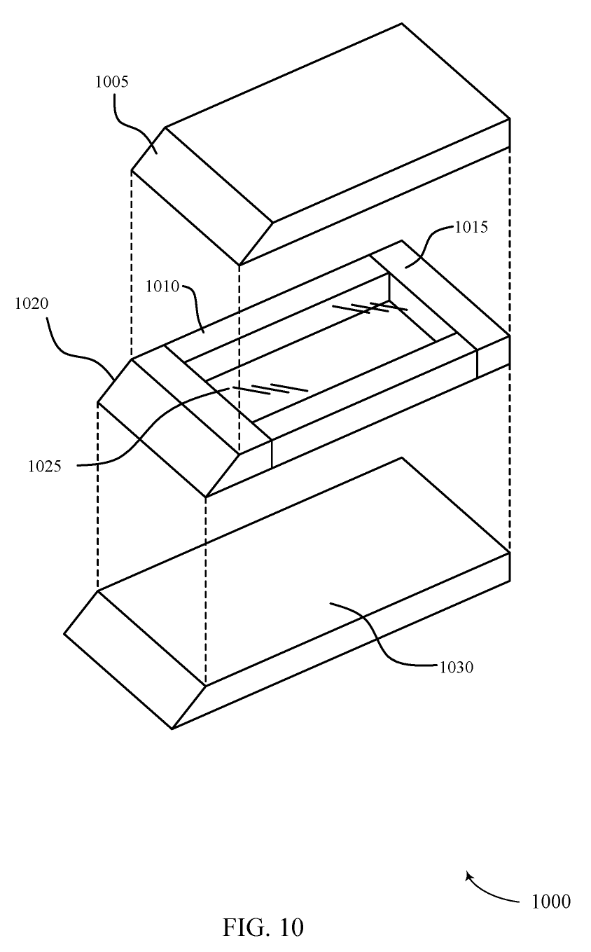

FIG. 9 illustrates an embodiment of an optical recording cell 900 that supports manufacturing holographic optical elements, in accordance with various aspects of the present disclosure. Optical recording cell 900 may illustrate embodied features and aspects of fabricated recording cells both pre-medium mixture dispersion and post-medium mixture dispersion, for example, as described in FIGS. 3A and 3B.

A pair of substrates 905, containing “LCD grade” glass may hold a middle layer 910 between the substrates 905. One or more optical and/or mechanical mechanisms (i.e., jig assembly, rail interferometry system, or the like) may ensure edge and/or surface alignment and sustain parallelism between substrates 905 and middle layer 910.

Optical recording cell 900 may be cut at an angle offset from surface normal of the top substrate of the pair of substrates 905. The cut angle may be representative of an edge angle for waveguide intercoupling, and optical recording cell 900 may be configured for use as a waveguide. The cut edge of optical recording cell 900 (i.e., leading edge) may be polished and function as an entrance pupil for optical recording cell 900 when implemented as a waveguide. The cut edge may be referred to as a beveled edge of optical recording cell 900.

FIG. 10 illustrates an embodiment of an optical recording cell 1000 that supports manufacturing holographic optical elements, in accordance with various aspects of the present disclosure. Optical recording cell 1000 may illustrate embodied features and aspects of fabricated recording cells both pre-medium mixture dispersion and post-medium mixture dispersion, for example, as described in FIGS. 3A and 3B. As referenced below, an edge may refer to a lateral component of optical recording cell 1000, based at least in part on a reference orientation of the optical recording cell. Similarly, a surface may refer to a longitudinal component of optical recording cell 1000, based at least in part on a reference orientation of the optical recording cell.

A pair of longitudinal shims 1010 may be aligned and implemented between a bottom substrate 1030 and top substrate 1005. Each of longitudinal shims 1010 may be substantially parallel, and edge aligned with the dimensions of each of bottom substrate 1030 and top substrate 1005. In addition, one or more lateral shims 1015 may be aligned and implemented between a bottom substrate 1030 and top substrate 1005. Each of lateral shims 1010 may be substantially parallel, and edge aligned with the dimensions of each of substrate 1030 and substrate 1005. The pair of longitudinal shims 1010 and the one or more lateral shims 1015 may function as both a seal and a spacer of the optical recording cell. Substrates 1030 and 1005 may contain “LCD grade” glass, and each of shims 1010 and 1015 may contain glass and/or polymer materials.

Subsequent to implementation of shims 1010 and 1015, the fabricated optical recording cell 1000 may be cut and polished at an angle offset to employ edge coupling at the optical recording cell 1000. The cut angle 1020 may be representative of an edge angle for waveguide intercoupling, and optical recording cell 1000 may be configured for use as a waveguide. The cut edge of optical recording cell 1000 (i.e., leading edge) may be polished and function as an entrance pupil for optical recording cell 1000 when implemented as a waveguide. The cut edge may be referred to as a beveled edge of optical recording cell 1000.

In some cases, polishing may occur preemptive to dispersing medium mixture 1025 into the region enclosed by shims 1010 and 1015, between substrates 1005 and 1030. Optical recording cell 1000 may be filled with medium mixture 1025 via a port associated with a gap inherent to the orientation of shims 1010 and 1015 adhered to top substrate 1005 and bottom substrate 1030. Alternatively, in some cases, one of lateral shims 1015, or a single shim from the pair of longitudinal shims 1010 may not be present within optical recording cell 1000 prior to dispersing of medium mixture 1025, and optical cell 1000 may be filled with medium mixture 1025 via the open region or aperture. Subsequently, the missing shim (e.g., one of lateral shims 1015, or a single shim from the pair of longitudinal shims 1010) may be oriented and integrated between top substrate 1005 and bottom substrate 1030 and adhered via the medium mixture 1025. The edge and/or port employed to fill optical recording cell 1000 with medium mixture 1025 may be sealed, and medium mixture 1025 may be polymerized to form a polymeric solvent referred to as a recording medium. In other cases, polishing may occur following dispersion of medium mixture 1025 into the region enclosed by shims 1010 and 1015, between substrates 1005 and 1030.

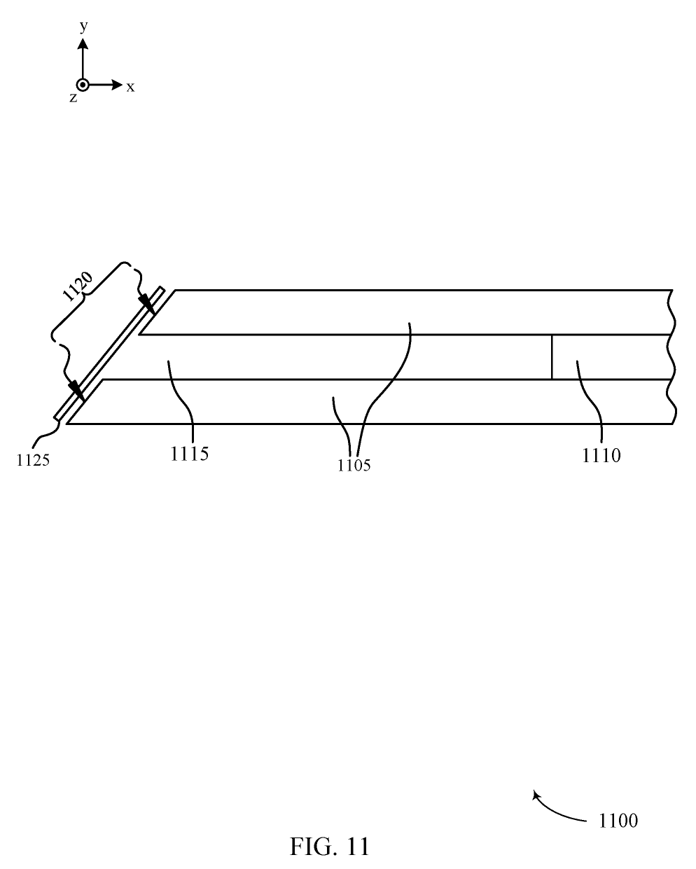

FIG. 11 illustrates an optical recording cell 1100 that supports manufacturing holographic optical elements, in accordance with various aspects of the present disclosure. The respective view (i.e., a side view) may correspond to a x,y planar region associated with the optical recording cell 1100. Optical recording cell 1100 may include methods and features as described with reference to FIGS. 9 and 10.

A number of shims 1110 may be placed along the length and/or at an end of optical recording cell 1100 between substrates 1105, as a means to at least provide structural support to the optical recording cell 1100. Within an embodiment of recording cell 1100, as illustrated, a shim may be intentionally excluded between substrates 1105 along a cut edge 1120 corresponding to an edge couple of optical recording cell 1100. The cut edge 1120 may be referred to as a beveled edge and may be used for employing at least a waveguide configuration of recording cell 1100.

Upon adhesion of shims 1110 with substrates 1105, and fabrication of recording cell 1100, medium mixture 1115 may be dispersed into the medial area spaced by shims 1110 via a port associated with cut edge 1120. A cover slip 1125 may be placed in alignment with the cut edge 1120 and may span at least the port and the cut region of substrates 1105. Cover slip 1125 may be index matched and adhered to the beveled edges 1120 of substrates 1105.

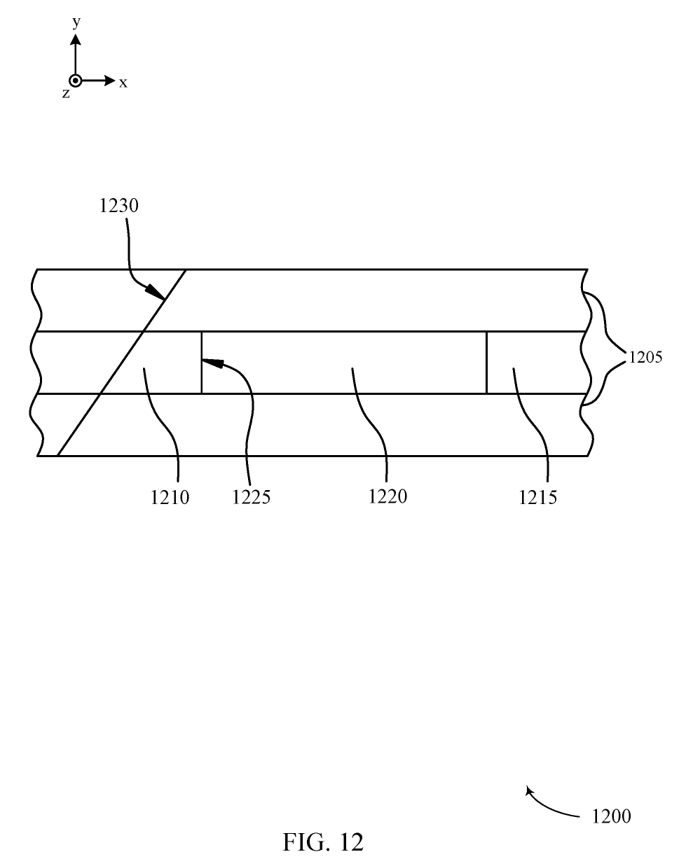

FIG. 12 illustrates an optical recording cell 1200 that supports manufacturing holographic optical elements, in accordance with various aspects of the present disclosure. The respective view (i.e., a side view) may correspond to a x,y planar region associated with the enclosed orientation axis of optical recording cell 1200. Optical recording cell 1200 may include methods and features of fabricated optical recording cells, as described with reference to at least FIGS. 9, 10, and 11.

A number of shims 1210, 1215, and 1220 may be placed along the length and/or at an end of optical recording cell 1100 between substrates 1205, as a means to at least provide structural support to the optical recording cell 1200. Each of shims 1210, 1215, and 1220 may have polished edges (e.g., 1225) and contain glass or polymer materials. Each of substrates 1205 may contain “LCD grade” glass. In some cases, polished edge 1225 may be coated with an absorptive coating, as a means to at least impede light from entering the side of the holographic media (e.g., medium mixture). An absorptive coating may be particularly beneficial in cases where the holographic media is not adequately index matched to the refractive index of the encapsulating substrates 1205.

Optical recording cell 1200 may be filled with the medium mixture via a port associated with a gap inherent to the orientation of shims 1210, 1215, and 1220 adhered to substrates 1205. Each of the shims 1210, 1215, and 1220 may then be sealed, and a recording medium formed from, in some cases, the recording medium may be photosensitive after formation of the matrix polymer but prior to exposure to photoinitiating light. A leading edge 1230 may then be cut at an angular offset, and polished to form an edge couple of optical recording cell 1200. The edge couple may be employed at optical recording cell 1200 as an entrance pupil for a waveguide configuration of optical recording cell 1200.

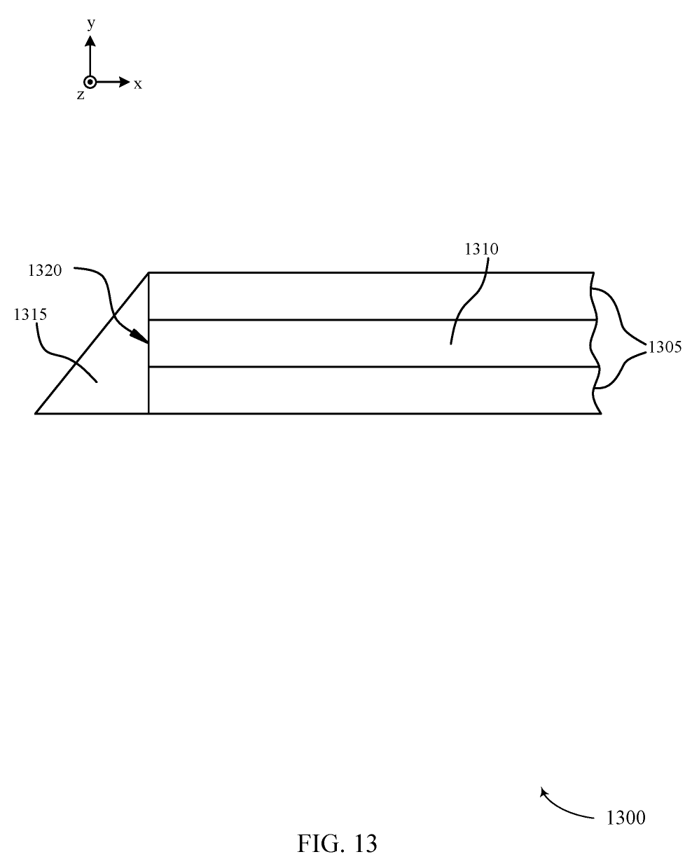

FIG. 13 illustrates an optical recording cell 1300 that supports manufacturing holographic optical elements, in accordance with various aspects of the present disclosure. The respective view (i.e., a side view) may correspond to a x,y planar region associated with the enclosed orientation axis of optical recording cell 1300. Optical recording cell 1300 may include methods and features of fabricated optical recording cells, as described with reference to at least FIGS. 9, 10, and 11.

One or more shims 1310 may be placed along the length and/or at an end of optical recording cell 1300 between substrates 1305, as a means to at least provide structural support to the optical recording cell 1300. Within an embodiment of recording cell 1300, as illustrated, a shim may be intentionally excluded between substrates 1105 along a polished edge 1320 proximal to an intercoupled prism 1315. Edge 1320 may correspond to a plural span of the edges of each of the substrates 1305, joined to prism 1315. Prism 1315 may be intercoupled with the substrates 1305 and one or more shims 1310 via an adhesive index matched to at least the substrates 1305 and/or shims 1310.

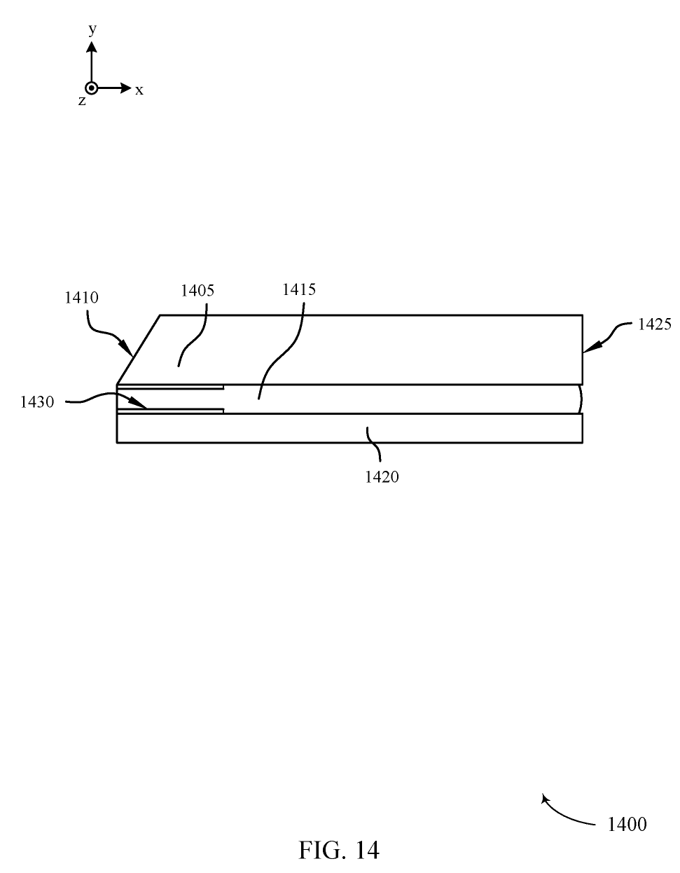

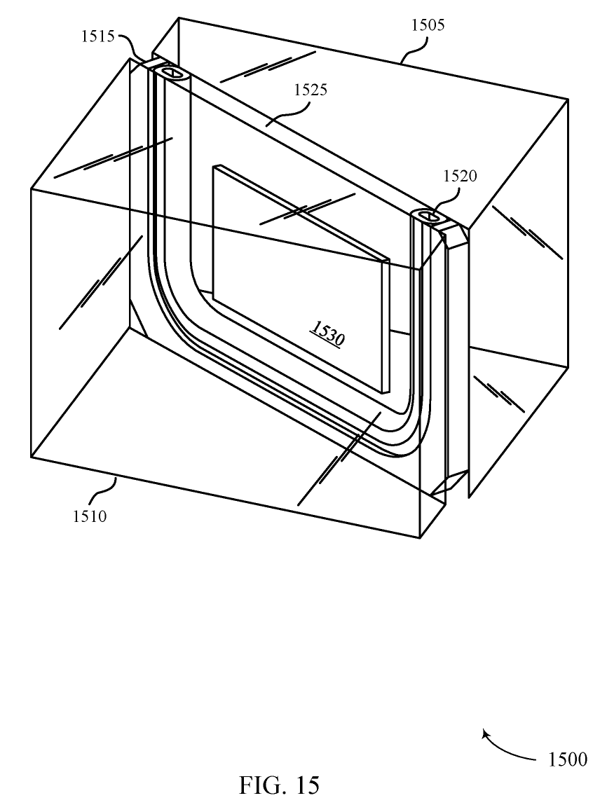

FIG. 14 illustrates an optical recording cell 1400 that supports manufacturing holographic optical elements, in accordance with various aspects of the present disclosure. The respective view (i.e., a side view) may correspond to a x,y planar region associated with the enclosed orientation axis of optical recording cell 1400. Optical recording cell 1400 may include methods and features of fabricated optical recording cells, as described with reference to at least FIGS. 9, 10, and 11.

A top substrate 1405 and bottom substrate 1420, containing “LCD grade” glass, may hold a middle layer 1415 between the substrates. One of more optical and/or mechanical mechanisms (i.e., jig assembly, rail interferometry system) may ensure edge and/or surface alignment and sustain parallelism between top substrate 1405, bottom substrate 1420, and middle layer 1415. Middle layer 1415 may be representative of an adhesive layer and/or a shim layer constructed of a glass or polymer entity that is sealed and may contain a dispensed media mixture from which a recording medium is formed.

In some embodiments, optical recording cell 1400 may be used as a waveguide, where top substrate 1405 may be used exclusively to perform edge coupling by a beveled edge 1410. Top substrate 1405 may exhibit a thickness sufficient to accept an input pupil of one or more configured sizes. The input pupil may be associated with incident light at the surface of beveled edge 1410. End 1425 of optical recording cell 1400 may be substantially uniform and unpolished, for implementation of optical recording cell 1400 as a waveguide. A partially reflective coating 1430 may be employed within a shim of middle layer 1415 (not shown) or at one or more of the substrates 1405 and 1420, as illustrated. Partially reflective coating 1430 may aid in mode homogenization of light beams (e.g., modes) propagating through optical recording cell 1400. In some cases, the homogenization of modes may occur within a region of optical recording cell 1400 that corresponds to one or more mode reflections within optical recording cell 1400, configured as a waveguide.

FIG. 15 illustrates a system 1500 for manufacturing a holographic optical element in accordance with various aspects of the disclosure. System 1500 may include the embodied features and methods described with reference to FIGS. 2A, 2B, and 2C. System 1500 may correspond to a perspective in reference to embodiments discussed in reference to at least FIGS. 2A, 2B, and 2C.

System 1500 may include a first and second coupling element 1505 and 1510, respectively, and a reservoir 1515 disposed between the first coupling element 1505 and the second coupling element 1510. In some cases, reservoir 1515 may be a generally rigid structure with respect to the coupling elements 1505 and 1510, as shown. In other cases, reservoir 1515 may span a volume extending beyond the coupling elements 1505 and 1510, to which coupling elements 1505 and 1510 are oriented and adhered at substrates of the reservoir 1515. Reservoir 1515 may include a sealing edge (e.g., chamber) 1520 for sustaining material properties. Chamber 1520 may exhibit pliability subject to a force exhibited by coupling element 1505 and/or coupling element 1510. For example, in some cases, coupling element 1505 and coupling element 1515 may experience a force directing the coupling elements to a common locale. The experienced force may direct pressure at reservoir 1515. As a result, the exhibiting pliable properties of chamber 1520 may enable malleability within the dimensionality of reservoir 1515, and aid in relieving the forces exhibited.

Reservoir 1515 may be filled with a fluid 1525, the fluid may be index-matched to the refractive index of at least one of coupling elements 1505 and 1510 at a range of wavelengths. The fluid 1515 may be classified according to the refractive index of the fluid 1525 being within a variant threshold of the index of refraction of the one or more respective coupling elements 1505 and/or 1510. For example, in some embodiments, the index-matched fluid 1525 may have an index of refraction, at a specified wavelength or range of wavelengths, within 0.10 of the index of refraction of the corresponding coupling element (e.g., first coupling element 1505, second coupling element 1510), and classified as “matched” to the coupling element. In other embodiments, the index-matched fluid 1525 may have an index of refraction, at a specified wavelength or range of wavelengths, within 0.025 of the index of refraction of the corresponding coupling element (e.g., first coupling element 1505, second coupling element 1510), and classified as “closely matched” to the coupling element. Furthermore, in other cases, the index-matched fluid 1525 may have an index of refraction, at a specified wavelength or range of wavelengths, within 0.010 of the index of refraction of the corresponding coupling element (e.g., first coupling element 1505, second coupling element 1510), and classified as “very closely matched” to the coupling element. The classification parameters provided are not intended to be exclusionary, rather they are provided as examples of index-matched fluid characterization.

By providing a force to a surface of a reservoir 1515, a surface defining the reservoir 1515 (e.g., a reservoir facing surface of one or both of the coupling element 1505 and 1510) may move closer to the recording medium 1530. In this manner, the force or pressure (i.e., caused by a mechanical force or suction force) applied by reservoir walls of the reservoir 1515 may aid in shaping the recording medium 1530 (e.g., the overall waveguide with substantially parallel opposing surfaces). This pressure provided by the force on the reservoir 1515 may cause a fluid layer of the index-matched fluid 1525 between the recording medium 1530 and the surface defining the reservoir 1515 to become thin (e.g., approximately less than a 10 microns fluid layer in some implementations). In some cases, the recording medium 1530 in a relaxed or unpressurized state within the reservoir 1515 may exhibit approximately between 1 and 10 waves of bend at a surface of the recording medium 1530. When flattened by pressure provided by the force on the reservoir 1515, the surface of the recording medium 1530 may be reduced to approximately a quarter wave of bend.

A recording medium 1530 may be at least partially submerged within the residing index-matched fluid 1525 of reservoir 1515. Recording medium 1530 may include a matrix polymer formed by polymerization of one or more matrix precursors, and a photoimageable system configured to form a photopolymer upon light induced polymerization. The photoimageable system may comprise a photoactive monomer and an initiator, and the matrix polymer may comprise a cross-linked support matrix. In some embodiments, the photoimageable system further comprises a terminator. The matrix precursor and the photoimageable system (or the polymers generated therefrom) are typically compatible with each other, and thus avoid phase separation before or after polymerization of either of the matrix precursor or the photoimageable system. The matrix precursor and photoimageable systems furthermore polymerize by reactions sufficiently independent from each other that the photoimageable system remains photosensitive after formation of the matrix polymer but prior to exposure to photoinitiating light. After the matrix polymer is formed, the photopolymer may covalently bond to the matrix polymer upon light-induced polymerization of the photoimageable system. Recording medium 1530 may be encapsulated by at least a pair of substrates and a sealed adhesive and/or shims, establishing an optical recording cell of the recording medium 1530. In some cases recording medium 1530 may be substantially parallel to the proximal substrates of at least one of coupling elements 1505 and 1510. In other cases, recording medium 1505 may be translated according to a lateral and/or longitudinal offset from center orientation of the reservoir 1515, according to the inset orientation axis and/or angularly offset from the proximate substrates of at least one of coupling elements 1505 and 1510.

In some embodiments mechanical and/or kinematic mounts (not shown) may be integrated with the optical recording cell containing recording medium 1530. The mechanical and/or kinematic mounts may include a clamp or fastener mechanism to hold the recording medium 1530, while sustaining stability and characteristic properties of the recording medium 1530, and surrounding substrates contained within the optical recording cell. Furthermore, in some embodiments, a motorized stage and/or robotic mechanism (not shown) may be implemented with the mounts to translate and/or rotate the optical recording cell within the reservoir 1515, for subsequent hologram programming at recording medium 1530. Translation of the optical recording cell may include a lateral or longitudinal offset of the optical recording cell within reservoir 1515, to position recording medium 1530 at an orientation between coupling elements 1505 and 1510 for subsequent hologram recording.

The implementation of a reservoir 1515, including index-matched fluid 1525, and/or a mechanical assembly (e.g., mechanical and/or kinematic mounts and/or a motorized stage/robotic mechanism) may allow for faster holographic optical element manufacturing, with increased throughput for hologram recording. For example, by at least partially submerging recording medium 1530 within index-matched fluid 1525 of reservoir 1515, time-consuming disassembly steps associated with manual sandwich methods direct to coupling elements may be obviated. The features of system 1500 may allow for increased efficiency in hologram recording, and therefore improved mechanisms for holographic optical element manufacture, while sustaining optical quality associated with holographic recording on a polymerized recording medium (e.g., recording medium 1530).

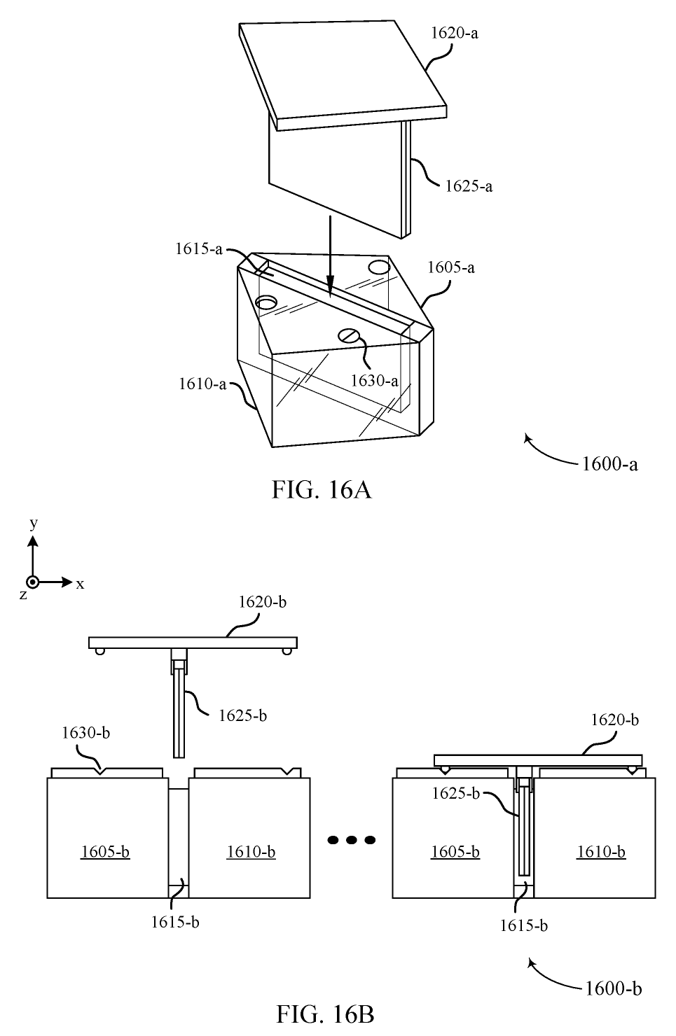

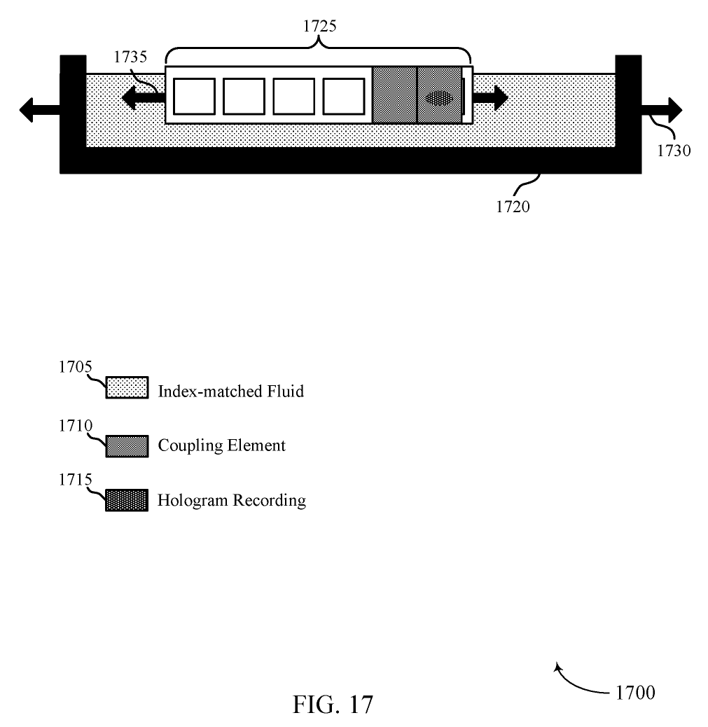

FIGS. 16A and 16B illustrate systems 1600-a and 1600-b that include embodied features that support manufacturing a holographic optical element in accordance with various aspects of the disclosure. System 1600 may include the embodied features and methods described with reference to FIG. 15. System 1500 may correspond to a perspective in reference to embodiments discussed in reference to at least FIG. 15.

System 1600-a illustrates an embodiment where a reservoir 1615-a may be disposed between a first coupling element 1605-a and a second coupling element 1610-a. In some cases, reservoir 1615-a may be a generally rigid structure with respect to the coupling elements 1605-a and 1610-a, as shown. In other cases, reservoir 1615-a may span a volume extending beyond the coupling elements 1605-a and 1610-a, to which coupling elements 1605-a and 1610-a are oriented and adhered at substrates of the reservoir 1615-a. Reservoir 1615-a may include a sealing edge or chamber (not shown) for sustaining material properties within reservoir 1615-a.

A precise holder (“rack”) 1620-a may be fastened to an optical recording cell 1625-a, including a polymerized recording medium. Rack 1620-a may employ one or more clamp elements as a means to secure optical recording cell 1625-a. Rack 1620-a may employ one or more kinematic mounts (e.g., bearings) to maintain stabilization of recording cell 1625-a. Optical recording cell 1625-a may be inserted into reservoir 1615, and oriented such that the one or more bearings of rack 1620-a are integrated with one or more alignment features 1630-a (e.g., sockets, detents, protrusions, etc.) of coupling elements 1605-a and 1610-a. Integrating the bearings of rack 1620-a with the one or more alignment features 1630-a may ensure stability of the kinematic mount, and sustain accuracy of the recording medium for holographic programming.

An optical means may emit one or more hologram recording beams, directed through at least one of coupling elements 1605-a and 1610-a and the index matched fluid of reservoir 1615-a, to the recording medium of optical recording cell 1625-a. The hologram recording beams may perform hologram recording at a locale of the polymeric recording medium, and each hologram may be configured to reflect light of a particular wavelength about a skew axis of the hologram recordings, according to a plurality of incidence angles. Each hologram may be formed using an exposure of the recording medium to coherent light having a particular wavelength. The plurality of incidence angles corresponding to each hologram may be offset from one another by a minimum range of angles.

System 1600-b illustrates an alternative view of one or more embodied features of system 1600-a, at disparate temporal instances. The respective view (i.e., a side view) may correspond to a x,y planar region associated with the enclosed orientation axis of system 1600-b. System 1600-b may employ static positioning of an optical recording cell 1625-b within a reservoir 1615-b disposed between a pair of coupling elements 1605-b and 1610-b. Reservoir 1615-b may contain a fluid index-matched to the refractive index of at least one of coupling elements 1605-b and 1610-b. A precise holder (“rack”) 1620-b may employ one or more clamp elements fastened to an optical recording cell 1625-b, including a polymerized recording medium. Rack 1620-a may employ one or more kinematic mounts (e.g., bearings) 1635 to maintain stabilization of recording cell 1625-a via integration with the one or more alignment features 1630-b of coupling elements 1605-b and/or 1610-b.

FIG. 17 illustrates a system 1700 that supports manufacturing a holographic optical element in accordance with various aspects of the disclosure. System 1700 may display one or more embodied features for faster hologram recording methods, corresponding to automated recording media translation as described in reference to FIGS. 16A and 16B. The embodied features may support holographic programming for a grouped array of recording cells.

System 1700 may include a reservoir 1720 that includes a pair of longitudinal surfaces and a pair of lateral edges. Reservoir 1720 may extend beyond the proximal surface area corresponding to a pair of coupling elements 1710 to which coupling elements 1710 may be oriented and adhered at substrates of the reservoir 1720 (e.g., at longitudinal surfaces). The longitudinal edges of reservoir 1720 may be substantially parallel, and sustain orthogonal corners with each of the lateral edges. In some cases, reservoir 1720 may include a sealing edge (e.g., chamber) that may exhibit pliability subject to a force exhibited by the pair of coupling elements 1710. Reservoir 1720 may include an index-matched fluid 1705 corresponding to at least a partial fill of the volumetric dimensionality of reservoir 1720.

A precise holder may be fastened to optical recording cell array 1725, and a motorized stage and/or robotic mechanism (not shown) may be implemented with the precise holder to translate and/or rotate optical recording cell array 1725 within the reservoir 1720. Translation of the optical recording cell may include a lateral offset 1735 to position a recording medium of a distinct recording cell at an orientation common to coupling elements 1710. In some cases, a separate motorized stage and/or robotic mechanism (not shown) may be implemented to translate reservoir 1720 at a lateral offset 1730, to obtain a desired recording beam angle for hologram programming at the respective recording medium.

An optical system may emit one or more hologram recording beams, directed through at least one of coupling elements 1710 and the index matched fluid of reservoir 1720, to the recording medium of the optical recording cell oriented common to coupling elements 1710. For example, a sample stage carrier of the optical system may be positioned on a sample carrier rail to facilitate the illumination of a first recording beam through at least one of coupling elements 1710, the index-matched fluid resident at reservoir 1720, and incident at the recording medium of the respective optical recording cell within optical recording cell array 1725. A reference mirror carrier may be positioned on the reference mirror carrier rail to facilitate the illumination of a second recording beam through at least one of coupling elements 1710, the index-matched fluid resident at reservoir 1720, and incident at the recording medium.

The optical system may be configured (i.e., the arrangement of a signal mirror and the reference mirror on the carrier rail) to direct the first recording beam and the second recording beam such that the recording beams intersect and interfere with each other to form an interference pattern that is recorded as a hologram 1715 in the recording medium. Multiple hologram recordings may be programmed at the recording medium of the respective optical recording cell, each configured to reflect light of a particular wavelength about a skew axis of the recording, at a plurality of incidence angles. Each hologram may be formed by an exposure of the recording medium to coherent light having a particular wavelength.

After hologram recording is complete, the recording medium of the respective optical recording cell may be treated with spatially and/or temporally incoherent light. Spatial incoherence may refer to a lack of phase interrelatedness (e.g., an equivalent frequency implying a constant phase difference) at modes of incident light. The spatially and/or temporally incoherent light may substantially eliminate photosensitivity of the support matrix precursors contained within the recording medium. The holography programmed (i.e., inclusion of hologram recordings) optical recording cell, including the treated recording medium, may be referred to as a holographic optical element. Subsequent to hologram recording and treatment (e.g., light treatment techniques) for each optical recording cell of the optical recording cell array 1725, the optical recording cells of optical recording cell array 1725 may be singulated. In some cases, the optical recording cells may be singulated via a wafer dicing saw. In other cases, the optical recording cells may be singulated via a laser-based dicing machine. The listed mechanisms for singulation are not intended to be exhaustive, but rather to exhibit embodied mechanisms.

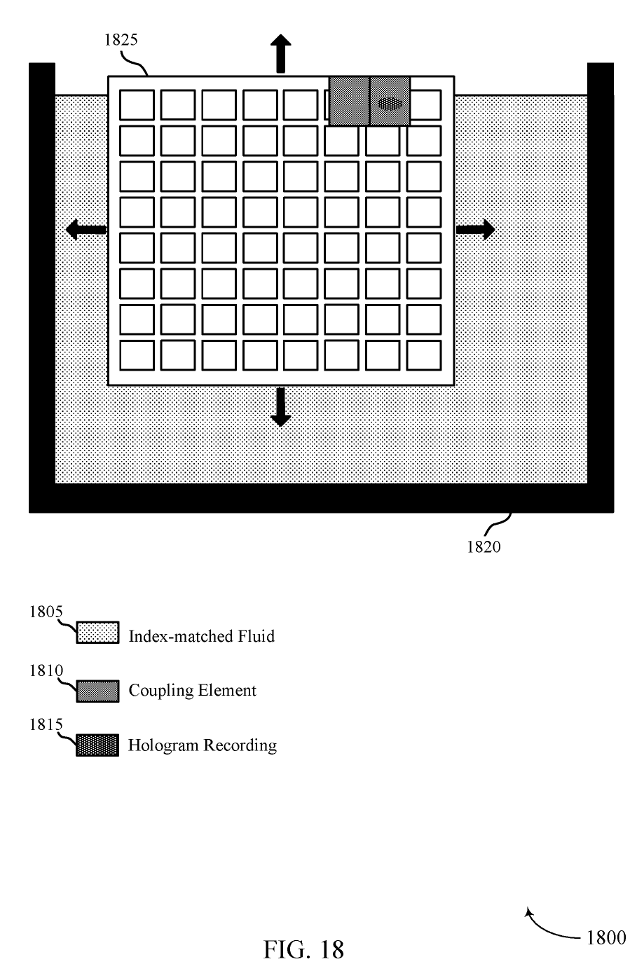

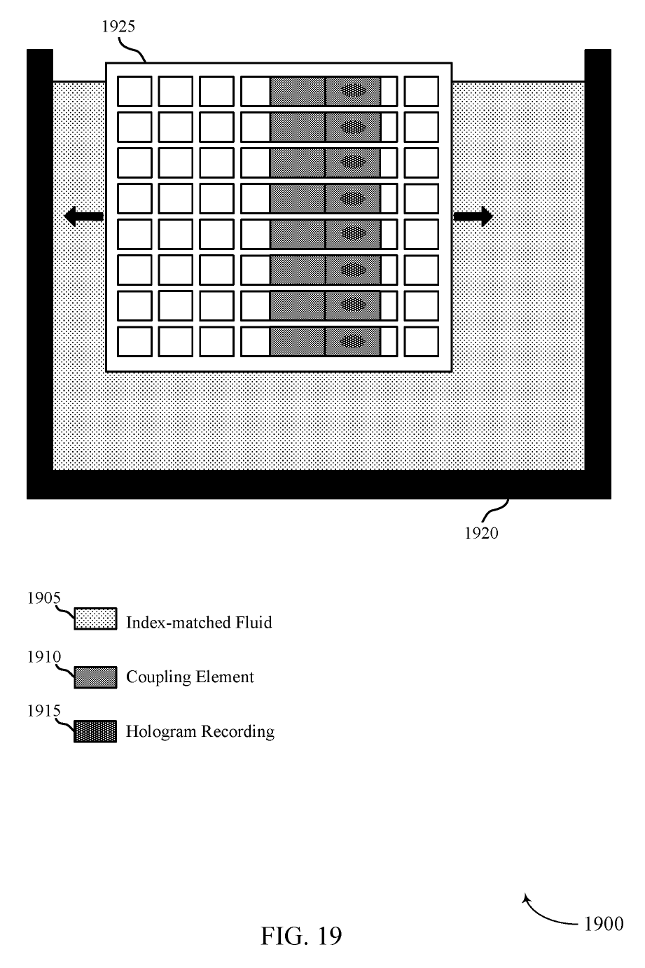

FIG. 18 illustrates a system 1800 that supports manufacturing a holographic optical element in accordance with various aspects of the disclosure. System 1800 may display one or more embodied features for faster hologram recording methods, corresponding to automated recording media translation, as described in reference to FIG. 17. The embodied features may support holographic programming for a grouped array of recording cells.

System 1800 may include a reservoir 1820 that includes a pair of longitudinal surfaces and a pair of lateral edges. Reservoir 1820 may promote a dimensionality extending beyond the proximal surface area corresponding to a pair of coupling elements 1810 to which coupling elements 1810 may be oriented and adhered at substrates of the reservoir 1820 (e.g., at longitudinal surfaces). The longitudinal edges of reservoir 1820 may be substantially parallel, and sustain orthogonal corners with each of the lateral edges. In some cases, reservoir 1820 may include a sealing edge (e.g., chamber) that may exhibit pliability subject to a force exhibited by the pair of coupling elements 1810. Reservoir 1820 may include an index-matched fluid 1805 corresponding to at least a partial fill of the volumetric dimensionality of reservoir 1820.

One or more precise holders may be fastened to 2-dimensional optical recording cell array 1825, multiple motorized stages and/or robotic mechanisms (not shown) may be implemented with the one or more precise holders to translate and/or rotate optical recording cell array 1825 within the reservoir 1820. Translation of the optical recording cell may include a lateral and/or longitudinal offset to position a recording medium of a distinct recording cell at an orientation common to coupling elements 1810. In some cases, one or more separate motorized stages and/or robotic mechanisms (not shown) may be implemented at one or more recording optics to obtain a desired recording beam angle for hologram programming at the respective recording medium.

The recording optics may emit one or more hologram recording beams, directed through at least one of coupling elements 1810 and the index matched fluid of reservoir 1820, to the recording medium of the optical recording cell oriented common to coupling elements 1810. The recording optics may be configured to direct a first recording beam and the second recording beam such that the recording beams intersect and interfere with each other to form an interference pattern that is recorded as a hologram 1815 in the recording medium. The multiple hologram recordings may be programmed at the recording medium of the respective optical recording cell, each configured to reflect light of a particular wavelength about a skew axis of the recording, at a plurality of incidence angles. Each hologram may be formed using an exposure of the recording medium to coherent light having a particular wavelength.

After hologram recording is complete, a the recording medium of the respective optical recording cell may be treated with spatially and/or temporally incoherent light. Spatial incoherence may refer to a lack of phase interrelatedness (e.g., an equivalent frequency implying a constant phase difference) at modes of incident light. The spatially and/or temporally incoherent light may substantially eliminate photosensitivity of the support matrix precursors contained within the recording medium. The holography programmed (i.e., inclusion of hologram recordings) optical recording cell, including the treated recording medium, may be referred to as a holographic optical element. Subsequent to hologram recording and treatment (e.g., optical curing) for each optical recording cell of the optical recording cell array 1825, the optical recording cells of optical recording cell array 1825 may be singulated.

FIG. 19 illustrates a system 1900 that supports manufacturing a holographic optical element in accordance with various aspects of the disclosure. System 1900 may display one or more embodied features for faster hologram recording methods, corresponding to automated recording media translation, as described in reference to FIGS. 17 and 18. The embodied features may support holographic programming for a grouped array of recording cells.

System 1900 may employ a plurality of coupling element pairs 1910 aligned to comprise a spatial duration of coupling element pairs at a common reference axis. Each coupling element pair may be adhered to substrates of reservoir 1920. Reservoir 1920 may promote a dimensionality extending beyond the proximal surface area corresponding to the column of coupling element pairs. Reservoir 1920 may include an index-matched fluid 1905 corresponding to at least a partial fill of the volumetric dimensionality of reservoir 1920.

One or more precise holders may be fastened to 2-dimensional optical recording cell array 1925. Multiple motorized stages and/or robotic mechanisms (not shown) may be implemented with the one or more precise holders to translate and/or rotate optical recording cell array 1925 within the reservoir 1920, including index-matched fluid 1905. Translation of the optical recording cell may include a lateral offset to position a recording medium of a distinct recording cell at an orientation common to the reference axis of the plurality of coupling elements 1910. In some cases, one or more separate motorized stages and/or robotic mechanisms (not shown) may be implemented at one or more recording optics to obtain a desired recording beam angle for hologram programming at the respective recording medium.

A plurality of recording optics may emit one or more hologram recording beams, directed through a particular pair of coupling elements 1910 and the index matched fluid of reservoir 1920, to the recording medium of the optical recording cell oriented common to the respective pair of coupling elements 1910. Specifically, each pair of coupling elements 1910 may have a set of recording optics configured for hologram recording at a recording medium oriented to the pair of coupling elements 1910. The recording optics may be configured to direct a first recording beam and a second recording beam such that the recording beams intersect and interfere with each other to form an interference pattern that is recorded as a hologram 1915 in the recording media The multiple hologram recordings may be programmed at the recording medium of the respective optical recording cell, each configured to reflect light of a particular wavelength about a skew axis of the recording, at a plurality of incidence angles. Each hologram may be formed using an exposure of the recording medium to coherent light having a particular wavelength.

After hologram recording is complete, each recording medium may be treated with spatially and/or temporally incoherent light. Spatial incoherence may refer to a lack of phase interrelatedness (e.g., an equivalent frequency implying a constant phase difference) at modes of incident light. The spatially and/or temporally incoherent light may substantially eliminate photosensitivity of the support matrix precursors contained within the recording medium. The holography programmed (i.e., inclusion of hologram recordings) optical recording cell, including the treated recording medium, may be referred to as a holographic optical element. Subsequent to hologram recording and treatment (e.g., optical curing) for each optical recording cell of the optical recording cell array 1925, the optical recording cells of optical recording cell array 1925 may be singulated.

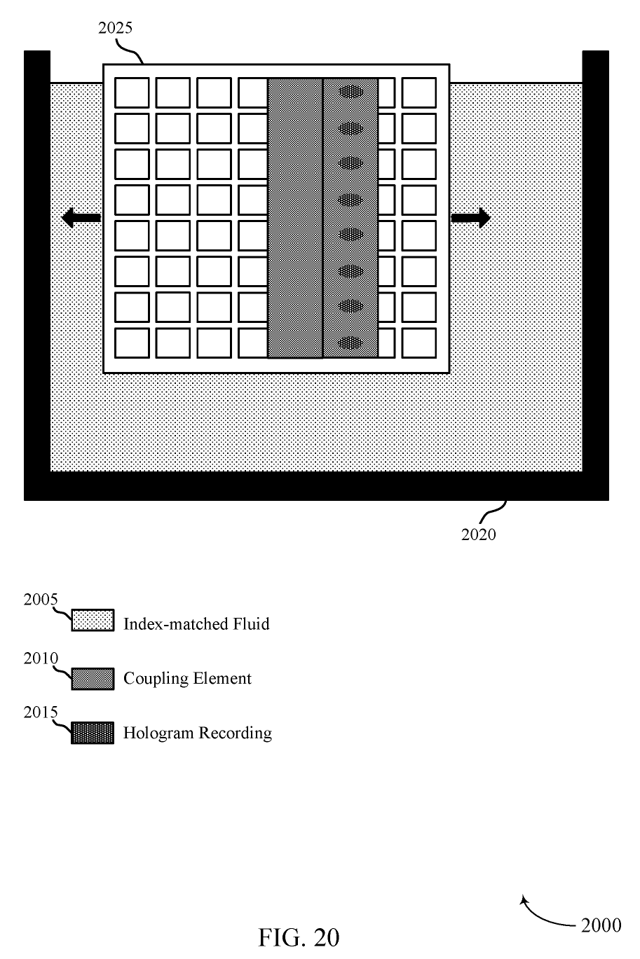

FIG. 20 illustrates a system 2000 that supports manufacturing a holographic optical element in accordance with various aspects of the disclosure. System 2000 may display one or more embodied features for faster hologram recording methods, corresponding to automated recording media translation, as described in reference to FIGS. 17 through 19. The embodied features may support holographic programming for a grouped array of recording cells.

System 2000 may employ an extended coupling element 2010 aligned to span one or more dimensions of 2-dimensional optical recording cell array 2025 at a common reference axis. Coupling element 2010 may be adhered to substrates of reservoir 2020. Reservoir 2020 may promote a dimensionality extending beyond the proximal surface area corresponding to the column of coupling element pairs. Reservoir 2020 may include an index-matched fluid 2005 corresponding to at least a partial fill of the volumetric dimensionality of reservoir 2020.

One or more precise holders may be fastened to 2-dimensional optical recording cell array 2025, multiple motorized stages and/or robotic mechanisms (not shown) may be implemented with the one or more precise holders to translate and/or rotate optical recording cell array 2025 within the reservoir 2020. Translation of the optical recording cell may include a lateral offset to position a plurality of recording media at an orientation common to the reference axis of extended coupling element 2010. In some cases, one or more separate motorized stages and/or robotic mechanisms (not shown) may be implemented at one or more recording optics to obtain a desired recording beam angle for hologram programming at the respective recording medium.

A plurality of recording optics may emit one or more hologram recording beams, directed through a configured sub-region of extended coupling element 2010 and the index matched fluid 2005 of reservoir 2020, to the recording medium of an oriented optical recording cell. Specifically, distinct recording optic of the plurality of recording optics may be configured for hologram recording at a recording medium oriented to a sub-region of the extended coupling element 2010. Each of the plurality recording optics may be configured to direct a first recording beam and a second recording beam such that the recording beams intersect and interfere with each other to form an interference pattern that is recorded as a hologram 2015 in the respective recording media. As illustrated, multiple holograms 2015 may be recorded as configured for each oriented recording medium with reference to extended coupling element 2010.

After hologram recording is complete, each recording medium may be treated with spatially and/or temporally incoherent light. Spatial incoherence may refer to a lack of phase interrelatedness (e.g., an equivalent frequency implying a constant phase difference) at modes of incident light. The spatially and/or temporally incoherent light may substantially eliminate photosensitivity of the recording medium. The holography programmed (i.e., inclusion of hologram recordings) optical recording cell, including the treated recording medium, may be referred to as a holographic optical element. Subsequent to hologram recording and treatment (e.g., optical curing) for each optical recording cell of the optical recording cell array 2025, the optical recording cells of optical recording cell array 2025 may be singulated.

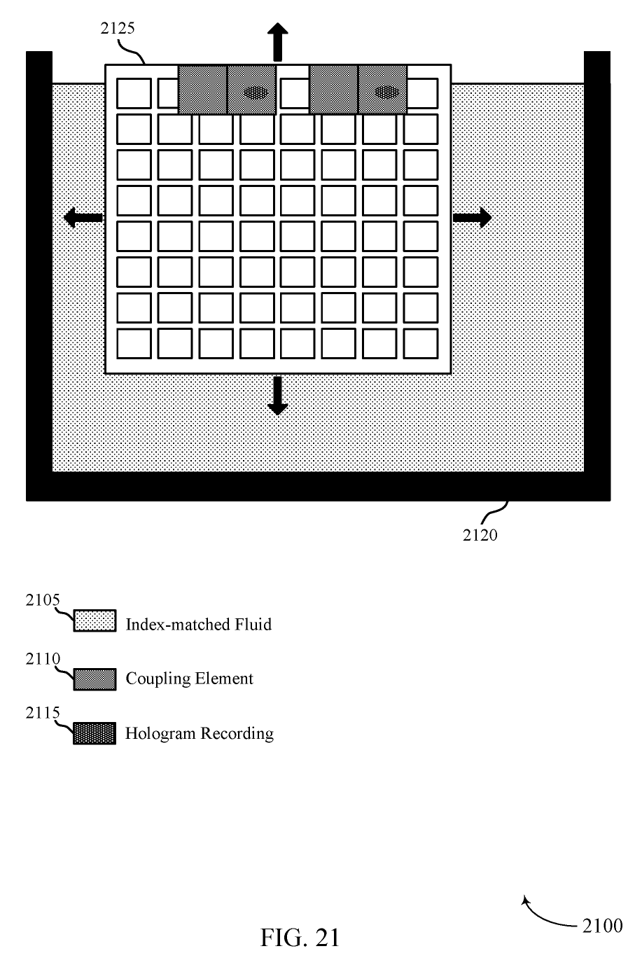

FIG. 21 illustrates a system 2100 that supports manufacturing a holographic optical element in accordance with various aspects of the disclosure. System 2100 may display one or more embodied features for faster hologram recording methods, corresponding to automated recording media translation, as described in reference to FIGS. 17 through 20. The embodied features may support holographic programming for a grouped array of recording cells.

System 2100 may employ a plurality of coupling element pairs 2110 oriented with reference to one another. Each coupling element pair may be adhered to substrates of reservoir 2120. Reservoir 2120 may promote a dimensionality extending beyond the proximal surface area corresponding to the column of coupling element pairs.

One or more precise holders may be fastened to 2-dimensional optical recording cell array 2125, multiple motorized stages and/or robotic mechanisms (not shown) may be implemented with the one or more precise holders to translate and/or rotate optical recording cell array 2125 within the reservoir 2120. Translation of the optical recording cell may include a lateral and/or longitudinal offset to position a recording medium of a distinct recording cell at an orientation common to coupling elements 2110. In some cases, one or more separate motorized stages and/or robotic mechanisms (not shown) may be implemented at one or more recording optics to obtain a desired recording beam angle for hologram programming at the respective recording medium.

Each of the one or more recording optics may be configured to program specific holographic functions at the recording medium of an oriented optical recording cell. Each of the one or more recording optics may emit one or more hologram recording beams, directed through a configured sub-region of extended coupling element 2110 and the index matched fluid 2105 of reservoir 2120, to the recording medium of an oriented optical recording cell. Each of the one or more recording optics may be configured to direct a first recording beam and a second recording beam such that the recording beams intersect and interfere with each other to form an interference pattern that is recorded as a hologram 2115 in the respective recording media.

After hologram recording is complete, each recording medium may be treated with spatially and/or temporally incoherent light. Spatial incoherence may refer to a lack of phase interrelatedness (e.g., an equivalent frequency implying a constant phase difference) at modes of incident light. The spatially and/or temporally incoherent light may substantially eliminate photosensitivity of the recording medium. The holography programmed (i.e., inclusion of hologram recordings) optical recording cell, including the treated recording medium, may be referred to as a holographic optical element. Subsequent to hologram recording and treatment (e.g., optical curing) for each optical recording cell of the optical recording cell array 2125, the optical recording cells of optical recording cell array 2125 may be singulated.

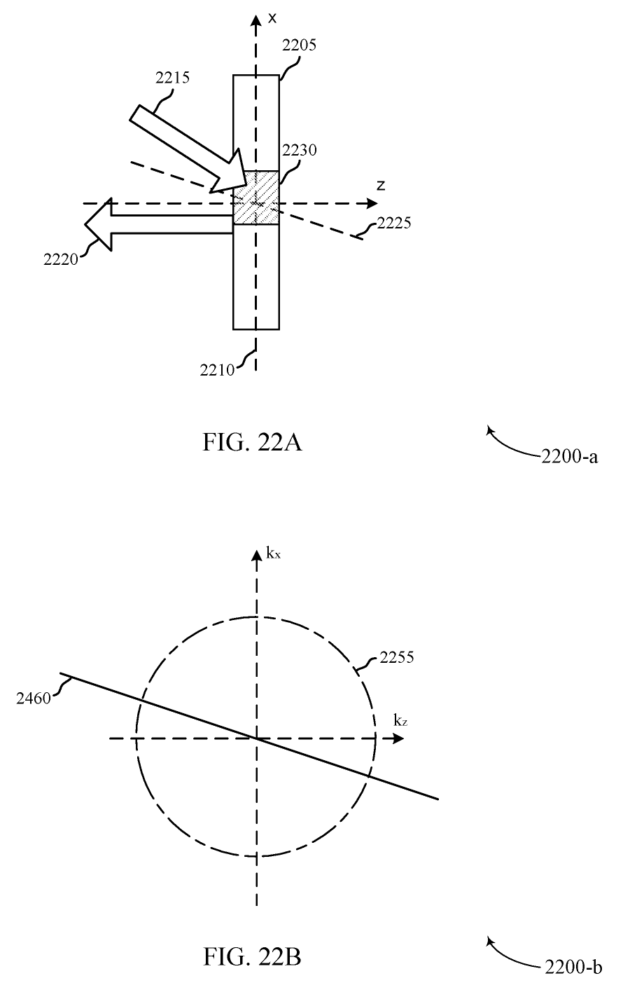

FIG. 22A is a cross-section view 2200-a illustrating reflective properties of a holographic optical element 2205 in real space, according to one example that supports manufacturing a holographic optical element in accordance with various aspects of the disclosure. The cross-section view 2200-a may include one or more recorded holograms, such as hologram 2230, in a recording medium. FIG. 22A omits holographic optical element components other than the recording medium, such as an additional layer that might serve as a substrate or protective layer for the recording medium. The substrate or protective layer may serve to protect the recording medium from contamination, moisture, oxygen, reactive chemical species, damage, and the like. In some embodiments, one or more holographic optical elements may be configured or structured to selectively reflect the rays of light to various portions of an optical device (e.g., redirecting light toward a waveguide in an input coupler configuration, redirecting light propagating in a TIR mode within an waveguide in a cross coupler configuration, and/or forming an exit pupil towards an eye box of the optical device). The holographic optical element may be configured to avoid reflecting the rays of light for certain incidence angles. Implementations of some holographic optical element embodiments may require a relatively high dynamic range recording medium to achieve high reflectivity over a relatively wide wavelength bandwidth and angle range for the resulting recording medium. By contrast, a holographic optical element may require less dynamic range thereby allowing each hologram to be stronger (e.g., recorded with a greater intensity and/or longer exposure time). A holographic optical element composed of stronger holograms may provide a brighter image, or allow a dimmer light projector to provide an image of similar brightness. The holographic optical element 2205 may be characterized by reflective axis 2225, at an angle measured with respect to the z-axis. The z-axis may be normal to the holographic optical element surface. The holographic optical element 2205 is illuminated with the incident light 2215 with an internal incidence angle that is measured with respect to the z-axis. The principal reflected light 2220 may be reflected with internal reflection angle 180° measured with respect to the z-axis. The principal reflected light 2220 may correspond to wavelengths of light residing in the red, green, and blue regions of the visible spectrum.

The holographic optical element 2210 may be characterized by the reflective axis 2225, at an angle measured with respect to the z-axis. The z-axis is normal to the holographic optical element 2205 axis. The holographic optical element 2210 is illuminated with the incident light 2215 with an internal incidence angle that is measured with respect to the z-axis. The principal reflected light 2220 may be reflected with internal reflection angle axis substantially normal to the surface of holographic optical element 2210. In some examples, the principal reflected light 2220 may correspond to wavelengths of light residing in the red, green, and blue regions of the visible spectrum. For example, the red, green, and blue regions of the visible spectrum may include a red wavelength (e.g., 610-780 nm) band, green wavelength (e.g., 493-577 nm) band, and blue wavelength (e.g., 405-492 nm) band. In other examples, the principal reflected light 2220 may correspond to wavelengths of light residing outside of the visible spectrum (e.g., infrared and ultraviolet wavelengths).

The holographic optical element 2210 may have multiple hologram regions which all share substantially the same reflective axis 2225. These multiple regions, however, may each reflect light for different ranges of angles of incidence. For example, the bottom third of a HOE containing the holographic optical element 2210 may only contain that subset of hologram recordings that reflects light upwards towards a corresponding eye box. The middle third may then reflect light directly towards the corresponding eye box. Then the top third need only contain the subset of hologram recordings which reflects light downwards to the corresponding eye box.

FIG. 22B illustrates a k-space representation 2200-b of the holographic optical element 2210 of FIG. 22A. The k-space distributions of spatially varying refractive index components are typically denoted Δn( [symbol] ). Δn( [symbol] ) k-space distribution 2260 may pass through the origin, at an angle equal to reflective axis 2225, measured with respect to the z-axis. Recording k-sphere 2255 may be the k-sphere corresponding to a particular writing wavelength. K-space representation 2200-b may include various k-spheres corresponding to wavelengths of light residing in the red, green, and blue regions of the visible spectrum. The k-space formalism may represent a method for analyzing holographic recording and diffraction. In k-space, propagating optical waves and holograms may be represented by three dimensional Fourier transforms of their distributions in real space. For example, an infinite collimated monochromatic reference beam may be represented in real space and k-space by equation (1):

$${E}_{r} ( \vec{r} ) = {A}_{r} exp ( i {\vec{k}}_{r} \cdot \vec{r} ) {}^{} {E}_{r} ( \vec{k} ) = {A}_{r} δ ( \vec{k} - {\vec{k}}_{r} ) \qquad ( 1 )$$

where Eᵣ ( [symbol] ) is the optical scalar field distribution at all [symbol] ={x, y, z} 3D spatial vector locations, and the transform Eᵣ ( [symbol] ) of the distribution, is the optical scalar field distribution at all [symbol] ={kₓ,k_{y},k_{z}} 3D spatial frequency vectors. Aᵣ may represent the scalar complex amplitude of the field; and [symbol] ᵣ may represent the wave vector, whose length indicates the spatial frequency of the light waves, and whose direction indicates the direction of propagation. In some implementations, all beams may be composed of light of the same wavelength, so all optical wave vectors may have the same length, i.e., | [symbol] ᵣ|=kₙ. Thus, all optical propagation vectors may lie on a sphere of radius kₙ=2πn₀/λ, where n₀ is the average refractive index of the hologram (“bulk index”), and λ is the vacuum wavelength of the light. This construct is known as the k-sphere. In other implementations, light of multiple wavelengths may be decomposed into a superposition of wave vectors of differing lengths, lying on different k-spheres. Another important k-space distribution is that of the holograms themselves. Volume holograms may consist of spatial variations of the index of refraction within a recording medium. The index of refraction spatial variations, typically denoted Δn( [symbol] ), can be referred to as index modulation patterns, the k-space distributions of which may be denoted Δn( [symbol] ). The index modulation pattern may be created by interference between a first recording beam and a second recording beam is typically proportional to the spatial intensity of the recording interference pattern, as shown in equation (22):

Δn( [symbol] )∝|E₁( [symbol] )=E₂( [symbol] )|²=|E₁( [symbol] )|²+|E₂( [symbol] )|²+E₁*( [symbol] )E₂( [symbol] )+E₁( [symbol] )E₂*( [symbol] ) (22)

where E₁( [symbol] ) is the spatial distribution of the signal first recording beam field and E₂( [symbol] ) is the spatial distribution of the second recording beam field. The unary operator * denotes complex conjugation. The final term in equation (22), E₁( [symbol] )E₂*( [symbol] ), may map the incident second recording beam into the diffracted first recording beam. Thus the following equation may result:

$${E}_{1} ( \vec{r} ) {E}_{2}^{*} ( \vec{r} ) {}^{} {E}_{1} ( \vec{k} ) ⊗ {E}_{2} ( \vec{k} ) , \qquad ( 3 )$$

where ⊗ is the 3D cross correlation operator. This is to say, the product of one optical field and the complex conjugate of another in the spatial domain may become a cross correlation of their respective Fourier transforms in the frequency domain.

Typically, the hologram 2230 constitutes a refractive index distribution that is real-valued in real space. Locations Δₙ( [symbol] ) of k-space distributions of the hologram 2230 may be determined mathematically from the cross-correlation operations E₂( [symbol] )⊗E₁( [symbol] ) and E₁( [symbol] )⊗E₂( [symbol] ), respectively, or geometrically from vector differences [symbol] = [symbol] ₁− [symbol] ₂ and [symbol] = [symbol] ₂− [symbol] ₁, where [symbol] and [symbol] may represent grating vectors from the respective hologram Δn( [symbol] ) k-space distributions to the origin (not shown individually). Note that by convention, wave vectors are represented by a lowercase “k,” and grating vectors by uppercase “K.”

Once recorded, the hologram 2230 may be illuminated by a probe beam to produce a diffracted beam. For purposes of the present disclosure, the diffracted beam can be considered a reflection of the probe beam, which can be referred to as an incident light beam (e.g., image-bearing light). The probe beam and its reflected beam may be angularly bisected by the reflective axis 2225 (i.e., the angle of incidence of the probe beam relative to the reflective axis has the same magnitude as the angle of reflection of the reflected beam relative to the reflective axis). The diffraction process can be represented by a set of mathematical and geometric operations in k-space similar to those of the recording process. In the weak diffraction limit, the diffracted light distribution of the diffracted beam is given by equation (4),

E_{d}( [symbol] )∝Δn( [symbol] )*Eₚ( [symbol] ) [symbol] , (4)

where E_{d}( [symbol] ) and Eₚ( [symbol] ) are k-space distributions of the diffracted beam and the probe beam, respectively; and “*” is the 3D convolution operator. The notation “ [symbol] ” indicates that the preceding expression is evaluated only where | [symbol] |=kₙ, i.e., where the result lies on the k-sphere. The convolution Δn( [symbol] )*Eₚ( [symbol] ) represents a polarization density distribution, and is proportional to the macroscopic sum of the inhomogeneous electric dipole moments of the recording medium induced by the probe beam, Eₚ( [symbol] ).

In some cases, when the probe beam resembles one of the recording beams used for recording, the effect of the convolution may be to reverse the cross correlation during recording, and the diffracted beam may substantially resemble the other recording beam used to record a hologram. When the probe beam has a different k-space distribution than the recording beams used for recording, the hologram may produce a diffracted beam that is substantially different than the beams used to record the hologram. Note also that while the recording beams are typically mutually coherent, the probe beam (and diffracted beam) is not so constrained. A multi-wavelength probe beam may be analyzed as a superposition of single-wavelength beams, each obeying Equation (4) with a different k-sphere radius.

Persons skilled in the art given the benefit of the present disclosure will recognize that the term probe beam, used when describing holographic optical element properties in k-space, is analogous to the term incident light, which is used when describing holographic optical element reflective properties in real space. Similarly, the term diffracted beam, used when describing holographic optical element properties in k-space, is analogous to the term principal reflected light, used when describing holographic optical element properties in real space. Thus when describing reflective properties of a holographic optical element in real space, it may be typical to state that incident light is reflected by a hologram (or other hologram recording) as principal reflected light, though to state that a probe beam is diffracted by the hologram to produce a diffracted beam is synonymous. Similarly, when describing reflective properties of a holographic optical element in k-space, it is typical to state that a probe beam is diffracted by a hologram (or other hologram recording) to produce a diffracted beam, though to state that incident light is reflected by the hologram recording to produce principal reflected light has the same meaning in the context of implementations of the present disclosure.

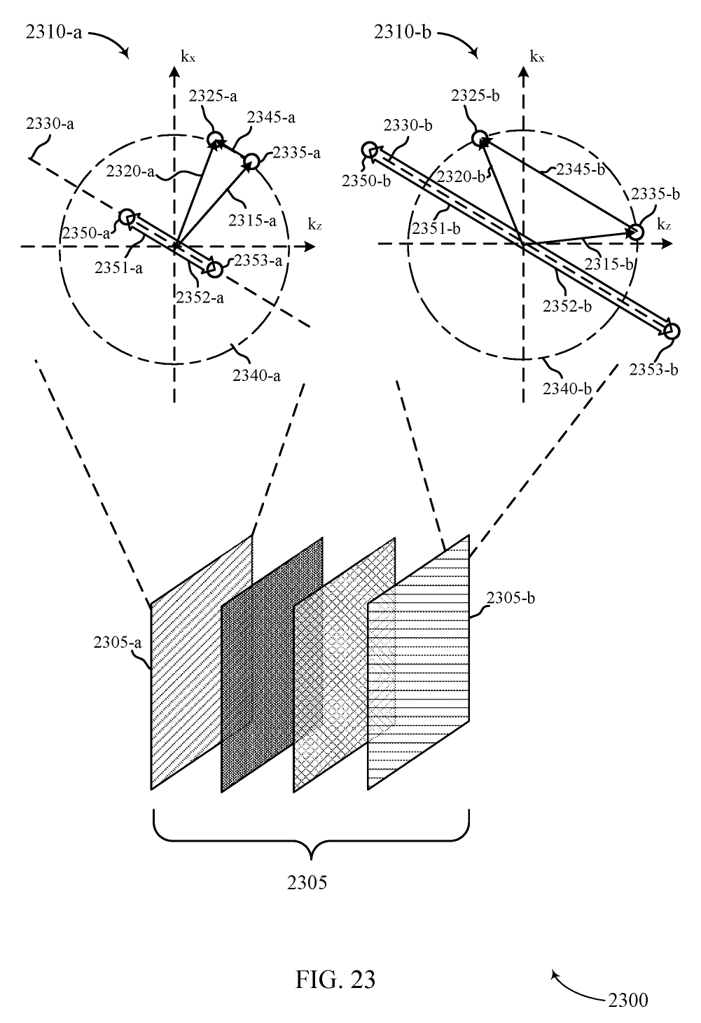

FIG. 23 is a diagram of an optical component 2300 illustrating a plurality of hologram recordings 2305 that support manufacturing a holographic optical element in accordance with various aspects of the disclosure. Hologram recordings 2305 may be similar to the hologram recordings with a recording medium described herein. In some cases, hologram recordings 2305 may be referred to as grating structures for reflecting light at a given wavelength, angle of incidence, or the like. Hologram recordings 2305 are illustrated in an exploded view manner for discussion purposes, but these hologram recordings 2305 may overlap and intermingle within a volume or space of a recording medium as described herein. Similarly each of the hologram recordings 2305 may be applied at spatial portions of a recording medium subject to a spatial disparity. Also, each hologram may have a different diffraction angle response and may reflect light at a wavelength that is different than another hologram recording.

Optical component 2300 depicts a hologram recording 2305-a and a hologram recording 2305-b. The hologram recording 2305-a may have a corresponding k-space diagram 2310-a, and the hologram recording 2305-b may have a corresponding k-space diagram 2310-b. The k-space diagrams 2310-a and 2310-b may illustrate cases of Bragg-matched reconstruction by illuminating a hologram.

The k-space diagram 2310-a may illustrate the reflection of an incident light by the hologram recording 2305-a. The k-space diagram 2310-a is a representation of a mirror-like diffraction (which can be referred to as a reflection) of the probe beam by the hologram, where the probe beam angle of incidence with respect to the reflective axis is equal to the diffracted beam angle of reflection with respect to the reflective axis. The k-space diagram 2310-a may include positive sideband Δn( [symbol] ) k-space distribution 2350-a that has an angle measured with respect to the z-axis, equal to that of the reflective axis 2330-a of the hologram recording 2305-a. The k-space diagram 2310-a may also include a negative sideband Δn( [symbol] ) k-space distribution 2353-a that has an angle measured with respect to the z-axis, equal to that of the reflective axis 2330-a. The k-sphere 2340-a may represent visible blue light, visible green light, or visible red light.

The k-space diagram 2310-a depicts a case where probe beam 2335-a produces a diffracted beam k-space distribution 2325-a, E_{d}( [symbol] ), that is point-like and lies on the probe beam 2340-a k-sphere. The diffracted beam k-space distribution 2325-a is produced according to the convolution of Equation (23).

The probe beam may have a k-space distribution 2335-a, Eₚ( [symbol] ), that is also point-like. In this case, the probe beam is said to be “Bragg-matched” to the hologram, and the hologram may produce significant diffraction, even though the probe beam wavelength differs from the wavelength of the recording beams used to record the hologram. The convolution operation may also be represented geometrically by the vector sum [symbol] _{d}= [symbol] ₚ+ [symbol] _{G+}, where [symbol] _{d} represents a diffracted beam wave vector 2320-a, [symbol] ₚ represents a probe beam wave vector 2315-a, and [symbol] _{G+} represents a positive sideband grating vector 2351-a. Vector 2345-a represents the sum of the probe beam wave vector 2315-a and the positive sideband grating vector 2351-a according to the convolution of Equation (23). The k-space diagram 2310-a also has a negative sideband grating vector 2352-a.

The probe beam wave vector 2315-a and the diffracted beam wave vector 2320-a may form the legs of a substantially isosceles triangle. The equal angles of this triangle may be congruent with the angle of incidence and angle of reflection, both measured with respect to the reflective axis 2330-a. Thus, the hologram recording 2305-a may reflect light in a substantially mirror-like manner about the reflective axis 2330-a.

The k-space diagram 2310-b may illustrate the reflection of an incident light by the hologram recording 2305-b. The hologram recording 2305-b may reflect incident light at a plurality of incidence angles that are different than the incidence angles reflected by the hologram recording 2305-a. The hologram recording 2305-b may also reflect light at a different wavelength than the hologram recording 2305-a. The k-space diagram 2310-b may be a representation of a mirror-like diffraction (which can be referred to as a reflection) of the probe beam by the hologram, where the probe beam angle of incidence with respect to the reflective axis is equal to the diffracted beam angle of reflection with respect to the reflective axis. The k-space diagram 2310-b has a positive sideband Δn( [symbol] ) k-space distribution 2350-b that has an angle measured with respect to the z-axis, equal to that of the reflective axis 2330-b of hologram recording 2305-b. The k-space diagram 2310-b also has a negative sideband Δn( [symbol] ) k-space distribution 2353-b that has an angle measured with respect to the z-axis, equal to that of the reflective axis 2330-b. The k-sphere 2340-b may represent visible blue light, visible green light, or visible red light. In some embodiments, the k-sphere may represent other wavelengths of electromagnetic radiation, including but not limited to ultraviolet or infrared wavelengths.

The k-space diagram 2310-b depicts a case where the probe beam 2335-b produces a diffracted beam k-space distribution 2325-b, E_{d}( [symbol] ), that is point-like and lies on the probe beam 2340-b k-sphere. The diffracted beam k-space distribution 2325-b is produced according to the convolution of Equation (23).

The probe beam 2335-b has a k-space distribution, Eₚ( [symbol] ), that is also point-like. In this case, the probe beam is said to be “Bragg-matched” to the hologram, and the hologram may produce significant diffraction, even though the probe beam wavelength differs from the wavelength of the recording beams used to record the hologram. The convolution operation may also be represented geometrically by the vector sum [symbol] _{d}= [symbol] ₚ+ [symbol] _{G+}, where [symbol] _{d} represents a diffracted beam wave vector 2320-b, [symbol] ₚ represents a probe beam wave vector 2315-b, and [symbol] _{G+} represents a positive sideband grating vector 2351-b. Vector 2345-b represents the sum of the probe beam wave vector 2315-b and the positive sideband grating vector 2351-b according to the convolution of Equation (23). The k-space diagram 2310-b also has a negative sideband grating vector 2352-b.

The probe beam wave vector 2315-b and the diffracted beam wave vector 2320-b may form the legs of a substantially isosceles triangle. The equal angles of this triangle may be congruent with the angle of incidence and angle of reflection, both measured with respect to the reflective axis 2330-b. Thus, the hologram recording 2305-b may reflect light in a substantially mirror-like manner about the reflective axis 2330-b.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein given the benefit of the present disclosure. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein throughout the entirety of the specification, should be understood to control over dictionary definitions, definitions in documents incorporated by reference, and/or ordinary meanings of the defined terms. The terms and phases described below are not to be accorded any special meaning by comparison with the other terms and phases described above and throughout the specification. Rather, the terms and phases described below are provided for additional clarity and as further examples of the subject technology in accordance with aspects of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 221.03.

The term “approximately,” refers to plus or minus 10% of the value given.

The term “reflective axis” refers to an axis that bisects an angle of incident light relative to its reflection. The absolute value of an angle of incidence of the incident light relative to the reflective axis is equal to the absolute value of the angle of reflection of the incident light's reflection, relative to the reflective axis. For conventional mirrors, the reflective axis is coincident with surface normal (i.e., the reflective axis is perpendicular to the mirror surface). Conversely, implementations of holographic optical elements according to the present disclosure may have a reflective axis that differs from surface normal, or in some cases may have a reflective axis that is coincident with surface normal. Persons skilled in the art given the benefit of the present disclosure will recognize that a reflective axis angle can be determined by adding an angle of incidence to its respective angle of reflection, and dividing the resulting sum by two. Angles of incidence and angles of reflection can be determined empirically, with multiple measurements (generally three or more) used to generate a mean value.

The term “reflection” and similar terms are used in this disclosure in some cases where “diffraction” might ordinarily be considered an appropriate term. This use of “reflection” is consistent with mirror-like properties exhibited by holographic optical elements and helps avoid potentially confusing terminology. For example, where a hologram recording is said to be configured to “reflect” incident light, a conventional artisan might prefer to say the hologram recording is configured to “diffract” incident light, since hologram recordings are generally thought to act on light by diffraction. However, such use of the term “diffract” would result in expressions such as “incident light is diffracted about substantially constant reflective axes,” which could be confusing. Accordingly, where incident light is said to be “reflected” by a hologram recording, persons of ordinary skill in art, given the benefit of this disclosure, will recognize that the hologram recording is in fact “reflecting” the light by a diffractive mechanism. Such use of “reflect” is not without precedent in optics, as conventional mirrors are generally said to “reflect” light despite the predominant role diffraction plays in such reflection. Artisans of ordinary skill thus recognize that most “reflection” includes characteristics of diffraction, and “reflection” by a holographic optical element or components thereof also includes diffraction.

The term “light” refers to electromagnetic radiation familiar to persons skilled in the art. Unless reference is made to a specific wavelength or range of wavelengths, such as “visible light”, which refers to a part of the electromagnetic spectrum visible to the human eye, the electromagnetic radiation can have any wavelength.

The terms “hologram” and “holographic grating” refer to a recording of an interference pattern generated by interference between multiple intersecting light beams. In some examples, a hologram or holographic grating may be generated by interference between multiple intersecting light beams where each of the multiple intersecting light beams remains invariant for an exposure time. In other examples, a hologram or holographic grating may be generated by interference between multiple intersecting light beams where an angle of incidence of at least one of the multiple intersecting light beams upon the recording medium is varied while the hologram is being recorded, and/or where wavelengths are varied while the hologram is being recorded (e.g., a complex hologram or complex holographic grating).

The term “sinusoidal volume grating” refers to an optical component which has an optical property, such as refractive index, modulated with a substantially sinusoidal profile throughout a volumetric region. Each (simple/sinusoidal) grating corresponds to a single complementary vector pair in k-space (or a substantially point-like complementary pair distribution in k-space).

The term “entrance pupil” refers to a real or virtual aperture passing a beam of light, at its minimum size, entering into imaging optics.

The term “eye box” refers to a two-dimensional area outlining a region wherein a human pupil may be placed for viewing the full field of view at a fixed distance from a hologram recording.

The term “exit pupil” refers to a real or virtual aperture passing a beam of light, at its minimum size, emerging from imaging optics. In use, the imaging optics system is typically configured to direct the beam of light toward image capture means. Examples of image capture means include, but are not limited to, a user's eye, a camera, or other photodetector.

The term “recording medium” refers to a physical medium that is configured with a hologram recording for reflecting light. A recording medium may include multiple hologram recordings. In some cases, a recording medium may include substrates or protective layers to protect the recording medium (or recording medium layer). In other cases, the recording medium may consist of a single layer of recording medium.

The term “hologram recording” refers to one or more gratings configured to reflect light. In some examples, a hologram recording may include a set of gratings that share at least one common attribute or characteristic (e.g., a same wavelength of light to which each of the set of gratings is responsive). In some implementations, a hologram recording may include one or more holograms. In other implementations, a hologram recording may include one or more sinusoidal volume gratings. In some examples, the hologram recordings may be uniform with respect to a reflective axis for each of the one or more gratings (e.g., holograms or sinusoidal gratings). Alternatively or additionally, the hologram recordings may be uniform with respect to a length or volume for each of the one or more gratings (e.g., holograms or sinusoidal volume gratings) within the recording medium.

The term “polarization” refers to a property applying to transverse waves that specifies the geometrical orientation of the oscillations. Light in the form of a plane wave in space may be classified as linearly polarized. Implicit in the parameterization of polarized light is the orientation of the reference coordinate frame. A common coordinate system relates to a plane of incidence of the light associated with the incoming propagation direction of the light and the vector perpendicular to the plane of interface. A ‘p’ polarization state may refer to linearly polarized light whose electric field is along (e.g., parallel) to the plane of incidence. A ‘s’ polarization state may refer to linearly polarized light whose electric field is normal to the plane of incidence. ‘P’ polarized light may also be referred to as transverse-magnetic (TM), pi-polarized, or tangential plane polarized light. ‘S’ polarized light may also be referred to as transverse-electric (TE), sigma-polarized, or sagittal plane polarized light.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

In the appended figures, similar components or features may have the same reference label. Further, various components of the same type may be distinguished by following the reference label by a dash and a second label that distinguishes among the similar components. If just the first reference label is used in the specification, the description may be applicable to any one of the similar components having the same first reference label irrespective of the second reference label.

What is claimed is:

1. A method of making one or more holographic optical elements, the method of making comprising:
at least partially submerging a recording medium in an index matching fluid residing in a fluid reservoir, wherein a first surface of the fluid reservoir comprises a surface of a first optical coupling element or a surface coupled to the first optical coupling element;
positioning the recording medium with respect to the surface of the first optical coupling element; and
applying a first recording beam through the first optical coupling element, the index matching fluid, and a first portion of the recording medium to form a hologram in the first portion of the recording medium.

2. The method of making of claim 1, further comprising:
applying a second recording beam through the first optical coupling element, the index matching fluid, and the first portion of the recording medium to form the hologram in the first portion of the recording medium.

3. The method of making of claim 1, wherein a second surface of the fluid reservoir comprises a surface of a second optical coupling element, the method further comprising:
applying a second recording beam through the second optical coupling element, the index matching fluid, and the first portion of the recording medium to form the hologram in the first portion of the recording medium.

4. The method of making of claim 3, wherein a plane of the first surface of the fluid reservoir is parallel to the a plane of the second surface of the fluid reservoir.

5. The method of making of claim 3, wherein the hologram in the first portion of the recording medium is formed based at least in part on interference between the first recording beam and the second recording beam.

6. The method of making of claim 1, further comprising:
applying a force to at least one of the first surface of the fluid reservoir or another portion of the fluid reservoir such that the first surface of the fluid reservoir moves closer to the recording medium.

7. The method of making of claim 1, wherein the index matching fluid has an index of refraction that is within 0.10 of an index of refraction of the first optical coupling element.

8. The method of making of claim 1, wherein the index matching fluid has an index of refraction that is within 0.025 of an index of refraction of the first optical coupling element.

9. The method of making of claim 1, wherein the index matching fluid has an index of refraction that is within 0.010 of an index of refraction of the first optical coupling element.

10. The method of making of claim 1, wherein the index matching fluid has an index of refraction that is within 0.025 of an index of refraction of the first optical coupling element when subject to a wavelength of the first recording beam and has an index of refraction that is greater than 0.10 of the index of refraction of the first optical coupling element when subject to a wavelength of light different from the wavelength of the first recording beam.

11. The method of making of claim 1, wherein the first recording beam has a wavelength of approximately 405 nm.

12. The method of making of claim 1, further comprising:
moving at least one of the recording medium, the first optical coupling element, or a position of the first recording beam with respect to at least one of the recording medium or the first optical coupling element; and
applying the first recording beam through the first optical coupling element, the index matching fluid, and a second portion of the recording medium different from the first portion to form a hologram in the second portion of the recording medium.

13. The method of making of claim 1, further comprising:
applying a second recording beam through the first optical coupling element, the index matching fluid, and a second portion of the recording medium different from the first portion to form a hologram in the second portion of the recording medium.

14. The method of making of claim 1, wherein the first surface of the fluid reservoir comprises a surface of a second optical coupling element, the method further comprising:
applying a second recording beam through the second optical coupling element, the index matching fluid, and a second portion of the recording medium different from the first portion to form a hologram in the second portion of the recording medium.

15. A method of making one or more holographic optical elements, the method of making comprising:
securing a first substrate substantially parallel to a second substrate, wherein the first substrate is spaced apart from the second substrate;
adding a media mixture to a space between the first substrate and the second substrate;
solidifying the media mixture to form a recording medium; and
applying a first recording beam through a first portion of the recording medium to form a hologram in the first portion of the recording medium.

16. The method of making of claim 15, further comprising:
adjusting, after adding a media mixture, a position of at least one of the first substrate or the second substrate.

17. The method of making of claim 15, further comprising:
dispensing adhesive material on a surface of at least one of the first substrate or the second substrate, wherein the adhesive material is dispensed proximal to a perimeter edge on the surface of the at least one of the first substrate or the second substrate for at least partially confining the media mixture between the first substrate and the second substrate.

18. The method of making of claim 15, wherein securing a first substrate substantially parallel to a second substrate comprises:
applying a suction force to a surface of at least one of the first substrate or the second substrate.

19. The method of making of claim 15, wherein at least one of a plurality of micrometers is used to adjust the position of at least one of the first substrate or the second substrate.

20. The method of making of claim 15, wherein an interferometry system is used to adjust the position of at least one of the first substrate or the second substrate.

21. The method of making of claim 15, wherein a spacer layer is disposed between the first substrate and the second substrate.

22. The method of making of claim 21, wherein the spacer layer includes two or more openings a space between the first substrate and the second substrate.

23. The method of making of claim 15, wherein securing a first substrate substantially parallel to a second substrate further comprises:
securing the first substrate substantially to a first optical flat and securing the second substrate to a second optical flat, and the method further comprising:
aligning the first substrate substantially parallel to the second substrate, the aligning based at least in part on positioning one or more calibrated spacers between the first optical flat and second optical flat.
